(19) United States
(12) Patent Application Publication
(10) Pub. No.: US 2017/0009036 A1
(43) Pub. Date: Jan. 12, 2017

(54) Structured Porous Metamaterial

(71) Applicant: RMIT UNIVERSITY, Victoria (AU)

(72) Inventors: Yi Min Xie, Rossana (AU); Jianhu Shen, Ringwood (AU); Shiwei Zhou, Balwyn (AU); Xiaodong Huang, Kew (AU)

(21) Appl. No.: 15/113,373

(22) PCT Filed: Jan. 20, 2015
(86) PCT No.: PCT/AU2015/000025

§ 371 Date: Jul. 21, 2016

(30) Foreign Application Priority Data
Jan. 24, 2014 (AU) 2014900227

(51) Int. Cl. C08J 9/00; B29C 67/00; B33Y 80/00; G01N 3/08; B33Y 10/00; B33Y 70/00

(52) U.S. Cl. CPC C08J 9/00; B33Y 10/00; B33Y 70/00; B33Y 80/00; G01N 3/08; B29C 67/0051; C08J 2383/04; C08J 2205/04; B29K 2083/00

(57) ABSTRACT

A structured porous metamaterial includes a three-dimensional matrix of at least one repeating base unit. The matrix is formed from an array of at least eight base units, each base unit including a platonic solid including at least one shaped void, wherein each base unit has void geometry tailored to provide a porosity of between 0.3 and 0.97, and to provide the metamaterial with a response that includes a Poisson's ratio of 0 to −0.5 when under tension and compression, or negative linear compression (NLC), negative area compression (NAC), zero linear compression (ZLC), or zero area compression (ZAC) behaviour when under pressure.

### TECHNICAL FIELD

The present invention generally relates to a three dimensional (3D) structured porous metamaterials with specific deformation pattern under applied loading, and more particularly a 3D structured porous metamaterials having a negative or zero Poisson's ratio and/or zero or negative compressibility (NC).

### BACKGROUND OF THE INVENTION

The following discussion of the background to the invention is intended to facilitate an understanding of the invention. However, it should be appreciated that the discussion is not an acknowledgement or admission that any of the material referred to was published, known or part of the common general knowledge as at the priority date of the application.

A material's Poisson's ratio is defined as the negative of the ratio of that materials lateral strain to its axial strain under uniaxial tension or compression. Most materials have a positive Poisson's ratio and therefore which expand laterally under compression and contract in the transverse direction under axial tension. Auxetic materials are materials with negative Poisson's ratio (NPR). The materials contract laterally under compression and expand in the transverse direction under axial tension.

Compressibility is a measure of the relative volume change of a solid or fluid as a response to a pressure change. Usually a material contracts in all directions when the pressure increases. However there are some exceptional materials which expand under hydrostatic pressure in one or two directions. Such phenomena are known as negative linear compressibility (NLC) and negative area compressibility (NAC), respectively.

In recent years, there has been increasing interest in the negative compressibility behaviour, mostly due to its many potential applications such as sensitive pressure sensors, pressure driven actuator and optical telecommunication cables. There are little artificial metamaterials with NLC or NAC available. As for metamaterial with NPR, Most of the currently available artificial metamaterials have a representative volume element having a complex topology. A number of auxetic elastomeric materials have also been developed, of which the following are examples:

Overvelde et al (Compaction Through Buckling in 2D Periodic, Soft and Porous Structures: Effect of Pore Shape. Advanced Materials. 2012; 24:2337-2342) teaches two dimensional soft cellular structures that comprise a solid matrix with a square array of holes. No three dimensional structures are investigated. The response of 2D porous structure to compression, including the Poisson's ratio of the material, are taught as being designed and tuned by changing the shape of the holes. Structures with a porosity φ of between 0.4 and 0.5 were identified as providing suitable auxetic properties. Structures with smaller porosity were noted to facilitate macroscopic instability leading to structures characterised by limited compaction. Structures with higher levels of porosity where also noted as leading to structures characterised by very thin ligaments, making them fragile.

United States Patent Publication No. 20110059291 A1 teaches both two dimensional and three dimensional structured porous materials having a porous structure provides a range in Poisson's ratio ranging from a negative Poisson's ratio to a zero Poisson's ratio. The geometry of the voids is suggested as being variable over a wide range of sizes and shapes. However, the exemplar structures consist of a pattern of elliptical or elliptical-like voids in an elastomeric sheet. The porous pattern of both two dimensional and three dimensional comprise a matrix of voids having a porosity φ of less than 0.5. The voids are located in the matrix as individual shapes within the base material, and are spaced apart in a regular pattern.

Babaee et al (3D soft metamaterials with negative Poisson's ratio. Advanced Materials. 2013; DOI: 10.1002/adma.201301986:1-6) teaches a new class of three-dimensional metamaterials with negative Poisson's ratio. A library of auxetic building blocks is identified and procedures are defined to guide their selection and assembly. The taught materials all comprise a three dimensional matrices of ball shaped building block units. Each ball building block includes shaped voids. The balls are stacked in a complex three dimensional array to form the metamaterial.

It would therefore be desirable to provide a new and/or improved three dimensional metamaterials with negative Poisson's ratio (NPR), negative linear compression (NLC), negative area compression (NAC), zero linear compression (ZLC), and/or zero area compression (ZAC) behaviour (NAC). In particular, it is preferable that this new auxetic metamaterial has a different and/or simpler structure than the metamaterial taught in Babaee et al.

### SUMMARY OF THE INVENTION

The present invention provides in a first aspect a structured porous metamaterial comprising a three-dimensional matrix of at least one repeating base unit, the matrix formed from an array of at least eight base units, each base unit comprising a platonic solid including at least one shaped void, wherein the geometry of the at least one shaped void of each base unit is tailored to:
provide a porosity of between 0.3 and 0.97; and
provide the metamaterial with a response comprising at least one of:
   a Poisson's ratio of 0 to −0.5 when under tension and compression; or
   negative linear compression (NLC), negative area compression (NAC), zero linear compression (ZLC), or zero area compression (ZAC) behavior when under pressure.

The present invention can therefore provide two broadly different properties through the inventive porous structure:

In a first embodiment, the present invention provides a structured porous metamaterial having a response under tension and compression having a Poisson's ratio of 0 to −0.5. This embodiment of the present invention comprises a simple building unit that provides a large and tuneable negative Poisson's ratio (NPR) strain range under both tension and compression. The negative and/or zero Poisson's ratio behavior of this metamaterial is a result of the mechanics of the deformation of the voids and the mechanics of the deformation of the solid base material.

In these embodiments, the porosity is preferably between 0.30 and 0.97. More preferably, the porosity is:
between 0.69 and 0.97 for a spherical shaped void;
between 0.30 and 0.90 for regular non-spherical shaped voids; or
between 0.3 and 0.98 for optimised shaped voids.

In some forms of this first embodiment, the present invention provides a structured porous metamaterial comprising a three-dimensional matrix of at least one repeating base unit, the matrix formed from an array of at least eight base units, each base unit comprising a platonic solid including at least one shaped void, wherein the geometry of the shaped void of each base unit is tailored to:
provide a porosity of:
   between 0.69 and 0.97 for a spherical shaped void;
   between 0.30 and 0.90 for regular non-spherical shaped voids; or
   between 0.3 and 0.98 for optimised shaped voids.
provide the metamaterial with a response comprising a Poisson's ratio of 0 to −0.5 when under tension and compression.

The inventors have found that contrary to the teaching of the prior art, the size and geometry of the void needs to be configured to provide a porosity φ of between 0.69 and 0.965 in the metamaterial with base unit comprising a cube with a spherical shaped void in order to provide the advantageous negative and/or zero Poisson's ratio behavior for the defined base unit. In this respect, the inventors have found that lower porosity values as taught as being essential in US20110059291 and Overvelde et al do not provide a three dimensional porous structure which displays tuneable negative and/or zero Poisson's ratio over a large compression strain, despite these characteristics being demonstrated as being displayed in the two and three dimensional structures. The desired properties and deformation characteristic of those materials can only be reproduced in three-dimensional structure through significant modification of the porous structure and geometry of the base unit and constituent void.

Without wishing to be limited by any one theory, the inventors consider that the negative Poisson's ratio of the metamaterial of the present invention is achieved through selection of the geometry and porosity of the material to create a desired alternating opening and closing deformation pattern of the voids and a specific configuration of the base unit which on compression allows spatial rotation and translation of part of the material of the base unit accompanied by the bending and stretching of other parts of the material of the base unit.

In a second embodiment, the present invention provides a structured porous metamaterial having a negative linear compression (NLC), negative area compression (NAC), zero linear compression (ZLC), or zero area compression (ZAC) behavior when under pressure. In these embodiments of the present invention, the metamaterial comprise a simplified building unit that provides NLC, NAC, ZLC, ZAC behaviour under pressure. In preferred forms, these building units are derived from bi-directional evolutionary structural optimization (BESO).

In these embodiments, the porosity is preferably between 0.30 and 0.97. More preferably, the porosity is between 0.3 and 0.95 for optimised shaped voids.

In some forms of this second embodiment, the present invention provides in a structured porous metamaterial comprising a three-dimensional matrix of at least one repeating base unit, the matrix formed from an array of at least eight base units, each base unit comprising a platonic solid including at least one optimised shaped void, wherein the geometry of the at least one shaped void of each base unit is tailored to:
provide a porosity of between 0.3 and 0.95 for optimised shaped voids; and
provide the metamaterial with a response comprising at least one of: negative linear compression (NLC), negative area compression (NAC), zero linear compression (ZLC), or zero area compression (ZAC) behavior when under pressure.

The matrix structure of the metamaterial of the present invention is formed from repeating adjacent base units. The metamaterial is formed from a three dimensional matrix formed from an array of at least eight base units, preferably arranged as a 2×2×2 matrix and preferably many more than eight base units arranged in a three dimensional matrix. The shape of the base unit is a platonic solid which enables the base unit to be arranged in a matrix without any voids or gaps between adjacent units. In preferred embodiments, the base unit comprises at least one of a tetrahedron, cube, cuboid, parallelepiped, octahedral, dodecahedron, or icosahedron. In one exemplary embodiment, the base unit comprises a six sided shape, preferably a cube, cuboid, parallelepiped, and more preferably a cube, more preferably a cubic symmetric platonic solid.

Each base unit includes a geometric center. In preferred embodiments, the geometry of the void is centered about the geometric center of the base unit, and more preferably the geometric center of each void is centered about the geometric center of the base unit. This provides a regular spacing between the center of adjacent void shapes throughout the matrix.

The negative Poisson ratio of the metamaterial can be tuned by using different base shape for the void and buckling mode of the representative element. For example, a material formed from a base unit including a void having a spherical base shape has a different negative Poisson ratio to a material formed from a base unit including a void having an ovoid base shape. Similarly, a material formed from a base unit including a void having a spherical base shape or an ovoid base shape has a different negative Poisson ratio to a material formed from a base unit including a void having an ellipsoid shape.

The void or voids within each base unit can have any suitable shape and configuration. The base shape of the void is preferably selected to provide desired tension and compression properties to the metamaterial. In some embodiments, wherein the base geometric shape of the voids comprises a spherical shape or at least one regular non-spherical shape such as ovoid, ellipsoid (including rugby ball shaped), cubic, cuboid, parallelepiped, hyperboloid, conical, octahedron, or other regular 3D polygon shape. In preferred forms, the void comprises a spherical, ovoid, or ellipsoid, more preferably spherical, or ovoid, and yet more preferably spherical.

In other embodiments, the void or voids can have a non-regular shape. For example, in some embodiments the void or voids can be formed from a combination of interconnected void shapes such as ovoid, ellipsoid (including rugby ball shaped), cubic, cuboid, parallelepiped, hyperboloid, conical, octahedron, or other regular 3D polygon shape.

In yet other embodiments, the base geometric shape of the voids comprises an optimised shape, thus comprising an optimised shape void. It is to be understood that an optimised shaped void is a shaped void having a configuration and shape derived from optimization algorithms, preferably bi-directional evolutionary structural optimization (BESO), to provide the desired response properties. The void shape is therefore has an optimised shape to provide these responses. Such optimised shaped voids typically have complex shapes and can comprise an amalgamation of a number of different regular shapes. Furthermore, optimised shaped voids can comprise two or more separate void shapes within the base unit. For example, a base unit may include three separate void spaces, the void spaces being generally located at the sides and one void around the geometric center of the base unit. Preferably, the void is shaped to assist in providing the metamaterial with at least one of a negative linear compression (NLC), negative area compression (NAC), zero linear compression (ZLC), or zero area compression (ZAC) behavior when under pressure.

As noted above, the porosity of the metamaterial and constituent base unit is an essential factor in the deformation characteristics of the metamaterial of the present invention. The porosity of the base unit is typically configured to be between 0.3 and 0.97. In preferred embodiments, the porosity is between 0.4 and 0.90, and more preferably between 0.50 and 0.90. In some embodiments, the porosity is between 0.60 and 0.90. In some embodiments, the porosity is between 0.3 and 0.80. In some embodiments, the porosity is between 0.69 and 0.90. In some embodiments, the porosity is between 0.50 and 0.97. In some embodiments, the porosity is between 0.60 and 0.97.

However, it should be appreciated that the effective porosity varies with the shape of void in the building cell. In embodiments, the void geometry of the base unit is preferably be tailored to provide a porosity of:
between 0.69 and 0.97 for a spherical shaped void;
between 0.30 and 0.90 for regular non-spherical shaped voids; or
between 0.3 and 0.98 for optimised shaped voids.

In those embodiments in which the metamaterial comprises a cubic base unit with a spherical void, the porosity is preferably between 0.69 and 0.97. In those embodiments in which the metamaterial comprises a cubic base unit with an ellipsoid void, the porosity is preferably between 0.3 and 0.875. In those embodiments in which the metamaterial includes an optimised shaped void the porosity is between 0.3 and 0.97 for optimised shaped voids, preferably between 0.40 and 0.90, and more preferably between 0.50 and 0.90.

The base unit comprises a platonic solid. For optimised shaped voids, the shaped void or voids in the base unit form spaces within that platonic solid which cut out or shape the solid material in the unit cell into the required form to provide the desired NLC, NAC, ZLC or ZAC property. For example, where the base unit comprises a cube, optimised shaped voids geometries are determined using optimization algorithms, for example bi-directional evolutionary structural optimization (BESO), to provide a unit cell structure with those properties.

The base unit typically includes a width, height and length. In some embodiments, at least one dimension of the base geometric shape of the void is larger than at least one of the width, height or length of the base unit. In such embodiments, the void comprises a truncated form of a base geometric shape. For example, where the base geometric shape of the void comprises a sphere and the base unit comprises a cube, the diameter of the sphere can be greater than the width, height and length of the cubic base unit. Similarly, where the base geometric shape of the void comprises an ellipsoid and the base unit comprises a cube, selected diameters of the ellipsoid can be greater than the width, height and length of the cubic base unit. The shape of the void will then be a truncated ellipsoid shape.

The truncation of the base geometric shape forms openings in the side of the base unit shape. In preferred embodiments, the void includes an opening in at least one, preferably two sides of the base unit. For example, where the base geometric shape of the void comprises a sphere and the base unit is cubic, the base spherical geometric shape would form circular openings in each of the side walls of the cubic base unit. More preferably, the void includes an opening in at least two opposing sides of the base unit. In this way, the void space of a first base unit is interconnected to the void space of at least two adjacent base units. In some embodiments, the void includes at least one opening in each (all) sides of the base unit.

For the first embodiment of the present invention, the configuration of the base unit, void geometry and pattern of the matrix formed from the base units can be tailored using a buckling mode obtained through Finite Element analysis, so that it provides a means to control the initial value of Poisson's ratio ranging from 0 to −0.5. In this respect, the desired deformation state of the material comprises adjacent voids being alternatively open and closed throughout the matrix. It can be advantageous to pattern the voids into that deformation pattern in order to force the voids to take that configuration when the material is subject to tension or compression. Accordingly, in some embodiments the base geometric shape of the void comprises shape having a greater central length than central height, the shape having a central length axis, the matrix of base units being arranged such that the central length axis of the void of each base unit is perpendicular to the central length axis of the void of each adjoining base unit. Preferably, the void shape comprises an ovoid or an ellipsoid, more preferably an ovoid.

In some embodiments, the metamaterial can comprise a three-dimensional matrix of at least two different repeating base units, comprising a first base unit comprising a platonic solid including at least a first shaped void and a second base unit comprising a platonic solid including a second shaped void. The first base unit and second base unit are preferably arranged in a pattern, preferably a regular pattern in the three-dimensional matrix. In some embodiments, the first shaped void has a different shape to the second shaped void.

The voids can have any suitable form. In some embodiments, the voids comprise an empty space framed by the material of the base unit. In other embodiments, the voids are composed of a compressible material, preferably having a high compressibility. In yet further embodiments, the voids include at least one fluid, preferably at least one liquid.

Where the voids hold a fluid, it is preferred for the geometry of the voids in the base unit is configured to allow the fluid flow through the voids in the matrix. In some applications of the metamaterial of the present invention, filling such voids with a fluid where the fluid acts as a dampening mechanism.

The base unit material can be any suitable base material. In some embodiments, the base unit material comprises a polymeric material. Exemplary polymeric materials include at least one of an unfilled or filled vulcanized rubber, natural or synthetic rubber, crosslinked elastomer, thermoplastic vulcanizate, thermoplastic elastomer, block copolymer, segmented copolymer, crosslinked polymer thermoplastic polymer, filled or unfilled polymer or epoxy. In other embodiments, base unit material comprises metallic and ceramic and composite materials. Exemplary metals include aluminium, magnesium, titanium, iron and alloys thereof.

In some embodiments, the base unit material comprises a biocompatible material, preferably a biocompatible polymeric material.

The structure and configuration of the metamaterial of the present invention can be determined using a number of methods. In some embodiments of the present invention, the configuration of a structured porous metamaterial according to the present invention is determined using structural optimisation algorithms, such as a bi-directional evolutionary structural optimization (BESO) modelling techniques.

A second aspect of the present invention provides a method of determining the configuration of a structured porous metamaterial comprising a three-dimensional matrix of at least one repeating base unit, comprising:
determining a base unit topology using a structural optimization algorithm, each base unit comprising a platonic solid including at least one shaped void, the geometry of the at least one shaped void of each base unit being tailored to provide a metamaterial with a porosity of between 0.3 and 0.97 and a response comprising at least one of:
   a Poisson's ratio of 0 to −0.5 when under tension and compression; or
   negative linear compression (NLC), negative area compression (NAC), zero linear compression (ZLC), or zero area compression (ZAC) behaviour when under pressure; and
simplifying the configuration of the at least one shaped void of each base unit to form a structural base unit; and
forming a three-dimensional matrix from an array of at least eight structural base units.

Whilst a number of any suitable structural optimisation algorithm or techniques could be used, in preferred embodiments, the configuration of the shaped voids within each base unit is derived from a bi-directional evolutionary structural optimization (BESO) model.

The step of simplifying the configuration of the at least one shaped void of each base unit is aimed at simplifying and/or optimizing the configuration of the base unit and resulting matrix for 3D printing construction. This step therefore preferably comprises reconfiguring the topology of the shaped void or voids to have a more regular geometric shape. This simplified configuration is typically more suitable for 3D printing construction.

It should be appreciated that this method is suitable for forming a structured porous metamaterial according to the first aspect of the present invention. The method of this second aspect is particularly suitable for forming metamaterial of the second embodiment of the first aspect of the present invention comprising optimised shaped voids which provide a structured porous metamaterial having a negative linear compression (NLC), negative area compression (NAC), zero linear compression (ZLC), or zero area compression (ZAC) behavior when under pressure.

The metamaterial of the present invention has potential to be used as a mechanism for redistributing the base material of the metamaterial according to the external loads so as to support external loading more effectively. Such a designed structural anisotropy can guide the loading into certain directions. Thus, this type of metamaterial could be designed to create complex stress-strain paths to protect a certain internal volume.

The tunable Poisson's ratio and/or compressibility of the present invention are a result of determining the deformation characteristics of the metamaterial during buckling of the structure when a force, preferably a compression force or pressure is applied to the material. This can be determined using a standard buckling analysis of the material, in which the deformation mechanism is determined. The deformation characteristics at buckling are termed the “buckling mode” of the base unit. The buckling mode provides the structure of deformation of the material. Once the buckling mode is determined, the structure of the base unit and more preferably of the void can then be modified to change (enhance or inhibit) the initial microstructure of the initial metamaterial and thus change/tune properties of the metamaterial such as the value of Poisson's ratio, effective strain range and/or compressibility for the desired NPR, NLC, NAC, ZLC, and/or ZAC behaviour of the material.

The present invention provides in a third aspect, a method of tuning the value of Poisson's ratio and effective strain range of a metamaterial according to the first aspect of the present invention. The method includes the steps of:

identifying the localized buckling mode of the metamaterial under compression through standard buckling analysis;

determining the representative volume element of the metamaterial and the deformation mechanism thereof during buckling;

determining a range of values of shape change of the representative volume element which modify the deformation mechanism thereof;

modifying the original base unit by superposition of the localized buckling mode of the metamaterial with a selected magnitude of shape change in the representative volume unit thereby enabling the value of the Poisson's ratio and effective strain range of the metamaterial to be tuned to a desired value.

Preferably, the shape of the void of the base unit is altered to modify the configuration of the base unit.

### BRIEF DESCRIPTION OF THE DRAWINGS

The present invention will now be described with reference to the figures of the accompanying drawings, which illustrate particular preferred embodiments of the present invention, wherein:

FIG. 1A provides the geometric configurations for a comparative three dimensional structure porous material without negative Poisson's ratio showing (A) the base cell unit; (B) a block of the comparative material comprising an 8×8×8 matrix of the base unit; and (C) representative volume unit of the comparative material.

FIG. 1B provides the geometric configurations for a three dimensional structure porous metamaterial according to the first embodiment of the present invention showing (A) the base cell unit; (B) a block of the inventive metamaterial comprising an 8×8×8 matrix of the base unit; and (C) representative volume unit of the inventive metamaterial.

FIG. 2 provides photographs of samples of the metamaterial shown in FIG. 1B (A) with supporting material fabricated using 3D printing and (B) without supporting material fabricated using 3D printing.

FIG. 3A shows the deformation patterns and thus buckling model for materials with (A) comparative a face-centred cubic cell (volume fraction: 51.0%) and (B) a cubic building cell according to the present invention (volume fraction: 12.6%).

FIG. 3B provides a view of force-displacement response of inventive metamaterial in two different directions D1 and D2.

FIG. 3C provides a comparison of nominal stress-strain curve of comparative structure porous material with face-centred cubic cell along three different loading directions.

FIG. 4 provides a comparison of deformation pattern of inventive metamaterial (volume fraction: 12.6%, load direction: D2 (FIG. 3), strain rate: 10⁻³ s⁻¹) between (A) experiment and (B) finite element model.

FIG. 5 provides a comparison of nominal stress-strain curve of inventive metamaterial between experiment and finite element model for spherical voids and slightly ovoid shaped voids shaped (spherical with imperfection).

FIG. 6 provides a comparison of deformation pattern of an embodiments of the inventive metamaterial including slightly ovoid shaped voids (volume fraction: 12.6%, strain rate: 10⁻³ s⁻¹) between (A) experiment and (B) finite element model.

FIG. 7A provides the geometric configurations for a three dimensional structure porous metamaterial with tetrahedron in cube building cell, showing (A) the base cell unit; (B) a block of the inventive metamaterial comprising an 8×8×8 matrix of the base unit; and (C) an isometric view of the representative volume unit of the inventive metamaterial.

FIG. 7B provides the geometric configurations for a three dimensional structure porous metamaterial with ellipsoid in cube building cell, showing (A) the base cell unit; (B) a block of the inventive metamaterial comprising an 8×8×8 matrix of the base unit; and (C) an isometric view of the representative volume unit of the inventive metamaterial.

FIG. 8A provides the deformation pattern for the metamaterial shown in FIG. 7A under load, showing (A) deformation pattern for bulk material (8×8×8) in xz plane; (B) deformation pattern for bulk material (8×8×8) in yz plane; (C) deformation pattern for the representative volume unit (2×2×2) in xz plane; and (D) an isometric view of the deformation pattern of the representative volume unit (2×2×2).

FIG. 8B provides the deformation pattern for the metamaterial shown in FIG. 7B under load, showing (A) deformation pattern for bulk material (8×8×8) in xz plane; (B) deformation pattern for bulk material (8×8×8) in yz plane; (C) deformation pattern for the representative volume unit (2×2×2) in xz plane; and (D) an isometric view of the deformation pattern for the representative volume unit (2×2×2).

FIG. 9 provides the geometric configurations for a three dimensional structure porous metamaterial with NLC according to the second embodiment of the present invention showing (A) the optimised building cell from BESO; (B) the simplified building cell unit; and (C) a block of the comparative material comprising an 8×8×8 matrix of the building cell unit.

FIG. 10 provides a comparison of deformation pattern of inventive NC metamaterial with NLC shown in FIG. 9 between (A) experiment and (B) finite element model; and (C) Comparison of strain-pressure history between FE results and experimental data for NLC material under pressure.

FIG. 11 provides the geometric configurations for a three dimensional structure porous metamaterial with NAC according to the second embodiment of the present invention showing (A) the optimised half building cell from BESO; (B) the optimised building cell from BESO; (C) the simplified building cell unit; and (D) a block of the material comprising an 8×8×8 matrix of the building cell unit.

FIG. 12 provides the geometric configurations for a three dimensional structure porous metamaterial with ZLC according to the second embodiment of the present invention showing (A) the optimised half building cell from BESO; (B) the optimised building cell from BESO; (C) the simplified building cell unit; and (D) a block of the material comprising an 8×8×8 matrix of the building cell unit.

FIG. 13 provides the geometric configurations for a three dimensional structure porous metamaterial with ZAC according to the second embodiment of the present invention showing (A) the optimised half building cell from BESO; (B) the optimised building cell from BESO; (C) the simplified building cell unit; and (D) a block of the material comprising an 8×8×8 matrix of the building cell unit.

### DETAILED DESCRIPTION

The present invention generally relates to a series of 3D structured porous metamaterial with specific deformation pattern under applied loading, and more particularly a 3D structured porous metamaterial having at least one of:
a negative Poisson's ratio under uniaxial tensile or compression; and/or
zero or negative compressibility under uniform pressure, such as negative linear compressibility (NLC), negative area compressibility (NAC), zero linear compressibility (ZLC) and/or zero area compressibility (ZAC).

The initial design of the microstructure of an auxetic metamaterial form of the present invention originates from using a three-dimensional repeating matrix formed from a base unit comprising a platonic solid such as a cube having a shaped void space such as a sphere or ellipsoid. The platonic solid provides a repeatable and stackable base structure, and the shaped void imparts the required characteristic to the void space and the surrounding base unit framework structure (around the void). The void geometry of each base unit is tailored to provide a porosity of between 0.3 and 0.97; and provide the metamaterial with a response under tension and compression having a Poisson's ratio of 0 to −0.5. The specific porosity depends on the type of shaped void used. Therefore the porosity is typically between 0.69 and 0.97 for a spherical shaped void; between 0.30 and 0.90 for regular non-spherical shaped voids; or between 0.3 and 0.97 for optimised shaped voids. Furthermore, as will be explained in more detailed below with reference to specific example material configurations, this structure imparts a tailored deformation character to the material, with the negative Poisson's ratios achieved through the a specific deformation characteristic of the voids (alternating opening and closing pattern of adjacent voids) in the material combined with the spatial rotation and translation of a rigid part of base unit material accompanied by the bending and stretching of the thinner or more flexible part of the base unit material.

The initial design of the microstructure of the zero or negative compressibility (NC) metamaterial form of the present invention originates from using a three-dimensional repeating matrix formed from a base unit comprising a platonic solid, such as a cube, having one or more shaped void spaces. The shape of the voids within that base unit and thus the topology of those building unit is derived from a bi-directional evolutionary structural optimization (BESO) model formed to provide the desired NC properties using the desired base unit (again for example a cube). That BESO result is then altered to simplify the topology of the void or voids to have a more regular shape. This simplified shape is typically more suitable for 3D printing construction. The platonic solid provides a repeatable and stackable base structure, and the shaped void or voids in the base unit cell (an optimised shaped void) imparts the required characteristic to the void space and the surrounding base unit framework structure (around the void). The void geometry (the optimised shape of the void or voids) of each base unit is tailored to provide a porosity of between 0.3 and 0.95; and provide the NC metamaterial with a response under uniform pressure having one of the following behaviour: NLC, NAC, ZLC and ZAC.

The material of the base unit can be polymeric including, but not limited to, unfilled or filled vulcanized rubber, natural or synthetic rubber, cross-linked elastomer, thermoplastic vulcanizate, thermoplastic elastomer, block copolymer, segmented copolymer, cross-linked polymer, thermoplastic polymer, filled or unfilled polymer, or epoxy. In other embodiments, the material of the base unit but may also be non-polymeric including, but not limited to, metallic and ceramic and composite materials. Exemplary metals include aluminium, magnesium, titanium, iron and alloys thereof.

Fabrication of 3D structures according to the present invention can be achieved through 3D printing, dissolving or melting patterned voids from a base material and sintering techniques well known in the art.

### Bi-Directional Evolutionary Structural Optimization (BESO)

The optimization method used for the initial design of the microstructure of the zero or negative compressibility (NC) metamaterial form of the present invention is based on the bi-directional evolutionary structural optimization (BESO). The basic idea of BESO is that by gradually removing inefficient material from a ground structure and redistributing the material to the most critical locations, the structure evolves towards an optimum.

For a 3D continuum material the ground structure is a unit cubic cell and the material properties (e.g. elasticity matrix) is determined using the homogenization theory. For NC forms of the present invention, the BESO method was applied to the design of materials of four types, namely, NLC, NAC, zero linear compressibility (ZLC) and zero area compressibility (ZAC).

### Determining Linear, Area and Volume Compressibilities of a Material by Homogenization

A cellular material consisting of a base material and voids is often modelled as a microstructure of a periodic base cell (PBC) using finite element (FE) analysis. According to the homogenization theory (Hassania, B., Hintona, E., 1998. A review of homogenization and topology optimization I—homogenization theory for media with periodic structure. Computers & Structures 69 (6), 707-717), the effective elastic constants can be expressed as

$${E}_{ij}^{H} = {\sum }_{e = 1}^{NE} ( \frac{1}{{Y}_{e}} {\int }_{{Y}_{e}} ( {ɛ}_{i}^{{0}^{T}} - {e}_{i}^{T} ) E ( {ɛ}_{j}^{0} - {ɛ}_{j} ) d {Y}_{e} ) \\ ( i , j = 1 to 6 for 3 D ) \qquad ( 1 )$$

where E is the elastic matrix of the base material, NE is the number of elements, εᵢ⁰ is the i-th unit strain field and εᵢ is the corresponding induced strain field.

For 3D materials, it involves applying six cases of periodic boundary conditions and unit strain fields. Then the 6×6 make up the elasticity matrix E^{H}. The homogenized compliance matrix C^{H} is the inverse of E^{H}, i.e.

C^{H}=[Cᵢⱼ]=E^{H-1} (2)

As the materials studied here is orthotropic, there is no axial-shear coupling and thus the 3×3 sub-matrix of the axial components can be extracted as below

$${C}_{A}^{H} = [ {C}_{ij}^{A} ] = [ \begin{matrix}{C}_{11} & {C}_{12} & {C}_{13} \\ {C}_{21} & {C}_{21} & {C}_{21} \\ {C}_{31} & {C}_{32} & {C}_{33}\end{matrix} ] = {E}_{A}^{{H}^{- 1}} \qquad ( 3 )$$

Based on the above compliance matrix, the linear compressibility in axis i (i=1, 2, 3) can be expressed as

β_{Li}=Cᵢ₁+Cᵢ₂+Cᵢ₃ (4)

which has the dimension of inverse of stress. The area compressibility in the ij plane is defined as

β_{Aij}=β_{Li}+β_{Lj}, i≠j (5)

and the volume compressibility as

βᵥ=_{L1}+β_{L2}+β_{L3} (6)

It is noted that Eq. (6) is the summation of the nine constants of the compliance matrix in Eq. (3), which is numerically equivalent to twice the strain energy of the microstructure under the unit hydrostatic stress. Since the strain energy is greater than or equal to zero, it is clear that for orthotropic materials the volume compressibility can either be positive or zero.

1. Negative Linear Compressibility

A typical optimization problem is usually defined in terms of the objective function(s) and constraints(s). Here an obvious choice of the objective function is the linear compressibility in a particular direction. For example, we may aim to minimize the compressibility in axis 3, β_{L3}=C₃₁+C₃₂+C₃₃. We choose the solid material as the initial design for the optimization process. For such an initial design, C₃₁ and C₃₂ are both negative and therefore β_{L3} can be re-written as β_{L3}=−(|C₃₁|+|C₃₂|)+C₃₃. It is noted that β_{L3} is initially positive and one way to “drive” it to become negative is to increase the weighing of the two negative terms, i.e. β_{L3}=−(p|C₃₁|−p|C₃₂|)+C₃₃ with p>1. Here p can be regarded as a stress factor or a penalty parameter: instead of the unit stress σ″={1,1,1}, a modified stress σ={p,p,1} is applied during the optimization process. The lower bound of p is 1, which must be reached on convergence. The upper bound of p is specified by assuming the linear compressibility equal to zero, i.e.

β_{L3}=p^{upper}C₃₁+p^{upper}C₃₂+C₃₃=0 (7a)

In order to maintain the orthotropy of the material, Eq. (7a) is re-written as

β_{L3}=½(p^{upper}C₃₁+p^{upper}C₃₂+p^{upper}C₁₃+p^{upper}C₂₃+2C₃₃)=0 (7b)

and p^{upper} is found to be

$${p}^{upper} = - \frac{2 {C}_{33}}{{C}_{31} + {C}_{32} + {C}_{13} + {C}_{23}} \qquad ( 7 c )$$

With pε[1, p^{upper}] specified, the value of p is to be determined. Because of the same p value being applied to axes 1 and 2, the resulting material is to be symmetrical to the 45 degree line in plane 1-2.

Next we discuss what constraints should be included in the optimization process apart from the volume constraint. As the NLC design is likely to be very flexible, it is necessary to prevent the design from becoming singular. In other words, we need to maintain reasonable stiffness. The stiffness in axis 3 is maintained by including C₃₃ in the objective function. The stiffness in axes 1 and 2 can be considered by specifying a constraint on C₁₁ and C₂₂, for example, by requiring them to be less than 1/E*, where E* is a prescribed stiffness target.

From the above discussions, the design of NLC materials can be treated as the following optimization:

$$\begin{matrix}Minimize {β}_{L 3} = \frac{1}{2} ( {pC}_{31} + {pC}_{32} + {pC}_{13} + {pC}_{23} + 2 {C}_{33} ) & ( 8 a ) \\ Subject to {C}_{11} \leq \frac{1}{{E}^{*}} & ( 8 b ) \\ {C}_{22} \leq \frac{1}{{E}^{*}} & ( 8 c ) \\ {C}_{11} = {C}_{22} & ( 8 d ) \\ p = 1 and & ( 8 e ) \\ {\sum }_{e = 1}^{NE} {V}_{e} {x}_{e} = V , {x}_{e} = {x}_{min} or 1 & ( 8 f )\end{matrix}$$

where V is the prescribed volume, Vₑ is the volume of element e, and xₑ is the design variable, with xₑ=xₘᵢₙ for void and xₑ=1 for solid.

The Lagrangian function combining the objective function and constraints is

$${f}_{L} = \frac{1}{2} ( {pC}_{31} + {pC}_{32} + {pC}_{13} + {pC}_{23} + 2 {C}_{33} ) + λ ( {C}_{11} - \frac{1}{{E}^{*}} ) + λ ( {C}_{22} - \frac{1}{{E}^{*}} ) \qquad ( 9 )$$

Since C₁₁=C₂₂, the same Lagrangian multiplier λ is applied to constraints (8b) and (8c).

### Sensitivity Analysis of Elasticity and Compliance Constants

The sensitivity of the Lagrangian function with respect to the design variable is

$$\frac{\partial {f}_{L}}{\partial {x}_{e}} = \frac{1}{2} ( p \frac{\partial {C}_{31}}{\partial {x}_{e}} + p \frac{\partial {C}_{32}}{\partial {x}_{e}} + p \frac{\partial {C}_{13}}{\partial {x}_{e}} + p \frac{\partial {C}_{23}}{\partial {x}_{e}} + 2 {C}_{33} ) + λ ( \frac{\partial {C}_{11}}{\partial {x}_{e}} + \frac{\partial {C}_{22}}{\partial {x}_{e}} ) \qquad ( 10 )$$

which calls for the sensitivity analysis of the compliance constants. To achieve this, the sensitivity of elasticity constants can be obtained by using the adjoint method (Bendsee, M. P., Sigmund, O., 2003. Topology optimization: theory, methods and applications 2nd ed. Springer, Berlin). From Eq. (1), the sensitivity of Eᵢⱼ^{H} can be expressed as

$$\frac{\partial {E}_{ij}^{H}}{\partial {x}_{e}} = \frac{1}{{Y}_{e}} {\int }_{{Y}_{e}} ( {ɛ}_{i}^{{0}^{T}} - {ɛ}_{i}^{T} ) \frac{\partial E}{\partial {x}_{e}} ( {ɛ}_{j}^{0} - {ɛ}_{j} ) d {Y}_{e} \qquad ( 11 )$$

The term

$$\frac{\partial E}{\partial {x}_{e}}$$

depends on the function used for interpolating the Young's modulus E. Here the interpolation scheme is based on”

$$E ( {x}_{e} ) = {E}_{b 1} + \frac{{x}_{e} ( {E}_{b 2} - {E}_{b 1} )}{1 + q ( 1 - {x}_{e} )} \qquad ( 12 )$$

where E_{b1} and E_{b2} are the Young's moduli of the base materials and q acts as a penalty factor. Typical values of q are equal to or greater than 3. For the examples considered in this paper, it is found that q=6 gives the best results. The present study is focused on designing cellular materials and therefore one of the base materials is void, i.e. either E_{b1} or E_{b2} is approaching zero.

Making use of Eq. (3), the sensitivity of the mean compliance matrix C^{H} is calculated by using the chain rule, i.e.

$$\frac{\partial {C}_{ij}}{\partial {x}_{e}} = {\sum }_{k , l = 1}^{3} \frac{\partial {C}_{ij}}{\partial {E}_{kl}^{H}} \frac{\partial {E}_{kl}^{H}}{\partial {x}_{e}} ( i , j = 1 to 3 ) \qquad ( 13 )$$

which can be calculated analytically by following a series of matrix operations.

### Sensitivity Number

The above sensitivity analysis forms the basis of the sensitivity number which is used as the search criterion in the BESO solution process. From Eq. (10), the sensitivity number is defined as

$${α}_{e} = - \frac{\partial {f}_{L}}{\partial {x}_{e}} \qquad ( 14 )$$

The sensitivity number αₑ is then filtered through a spherical range of radius rₘᵢₙ to obtain a weighted ‘average’, i.e.

\tilde{α}ₑ=ƒ(αₑ) (15)

Taking the centre of a brick element e as reference, the neighbouring elements within the radius rₘᵢₙ are included for the calculation of the average sensitivity of element e. The contributions from neighbouring elements depend on the sensitivity of each element and its distance to element e. Details of the filtering methodology are presented in Huang, X., Xie, Y. M., 2010. Evolutionary Topology Optimization of Continuum Structures: Methods and Applications. John Wiley & Sons, Chichester, England, the contents of which should be understood to be incorporated into this specification by this reference.

The sensitivity of the compliance matrix is filtered in the same way, i.e.

$$\frac{\partial {\tilde{C}}_{ij}}{\partial {x}_{e}} = f ( \frac{\partial {C}_{ij}}{\partial {x}_{e}} ) \qquad ( 16 )$$

Assuming there are totally m elements modified in one iteration, the increment of C^{H} is then

$$Δ {C}_{ij} \approx {\sum }_{e = 1}^{m} \frac{\partial {\tilde{C}}_{ij}}{\partial {x}_{e}} Δ {x}_{e} \qquad ( 17 )$$

The predicted mean compliance after the modification is

Cᵢⱼ′≈Cᵢⱼ+ΔCᵢⱼ (18)

### BESO Procedure

Like most numerical methods based on sensitivity analysis, BESO performs the search for the optimal solution iteratively until certain criteria are satisfied. Details of the solution procedure are as follows:

### A. Parameters

There are three parameters which control the step length of iteration, namely the evolutionary ratio ER, the maximum ratio Rₘₐₓ and the maximum ratio of added elements ARₘₐₓ. Assume that there are totally NE elements in the design domain and the volume constraint (the target volume) is V. The volumes of the current and the next iterations are V^{k} and V^{k+1}, respectively. V^{k+1} is predicted as V^{k+1}=V^{k}(1−ER) and the threshold for element modification is set as

NEₜₕᵣₑ=NE×V^{k+1}=NE×V^{k}(1−ER) (19)

The modification according to the threshold is conducted as follows. First, sort the sensitivity numbers of the NE elements in a descend order. Then void elements above the threshold NEₜₕᵣₑ are switched to solid, and solid elements below the threshold are switched to void. As a result, the total numbers of elements removed and added are NR and NA, respectively.

The net number of modified element is NR−NA, which is positive if the volume is approaching from the initial high value to the target. A parameter ARₘₐₓ is introduced to ensure that the number of added elements in one iteration is not too large, i.e. when the ratio NA/NE exceeds ARₘₐₓ, NA is reduced to NAₘₐₓ=ARₘₐₓNE.

Also, it is required that the total of NR and NA (or NAₘₐₓ if applicable) is not too high, that is,

$$\frac{NR + NA}{NE} \leq {R}_{max} \qquad ( 20 )$$

If the ratio is exceeded, the numbers of removed and added elements are reduced according to the following equations:

$$\begin{matrix}{NR}^{′} = {R}_{max} \times NE \times \frac{NR}{NR + NA} & ( 21 ) \\ {NA}^{′} = {R}_{max} \times NE \times \frac{NA}{NR + NA} & ( 22 )\end{matrix}$$

### B. The Overall Procedure

The outer loop of the BESO procedure is as follows:
1. Discretize the periodic base cell with finite elements and define the initial design.
2. Apply the periodic boundary conditions and corresponding unit strain fields.
3. For each boundary and unit strain case, conduct finite element analysis to obtain the induced strain field ε.
4. Calculate the elasticity matrix E^{H} and the compliances matrix C^{H}.
5. Determine the stress factor p and the Lagrangian multipliers λ (inner loops), as detailed in Section C—Stress factor and Lagrangian multipliers.
6. Calculate the sensitivity number \tilde{α}ₑ using Eqs. (11˜15).
7. Update the topology of the base cell according to \tilde{α}ₑ, using the threshold and parameters as detailed in Section A—Parameters.
8. Repeat Steps 2 to 7 until the objective function is stabilized between iterations.

### C. Stress Factor and Lagrangian Multipliers

In Eq. (9) the Lagrangian function ƒ_{L} has two unknowns, namely the stress factor p and the Lagrangian multiplier λ associated with the stiffness constraints. If the constraint is too stringent, i.e. the value of

$$\frac{1}{{E}^{*}}$$

is too small, the objective compressibility may not be reduced enough to be below zero. Therefore

$$\frac{1}{{E}^{*}}$$

should be reasonably high to allow the structure to be sufficiently flexible. In the early stage of iterations (starting from a solid structure as the initial design), the structure is quite stiff with the constraint

$${C}_{11} < \frac{1}{{E}^{*}}$$

being satisfied and thus the Lagrangian multiplier is λ=0. Only the stress factor p needs to be solved at this stage. As the iterations continue, p will converge to unit and the stiffness will gradually reduce till C₁₁ becomes greater than

$$\frac{1}{{E}^{*}} .$$

At this point the Lagrangian multiplier λ becomes activated and needs to be solved. Once p and λ are solved, they are averaged between the current and the last iterations, respectively.

### D. Determination of the Stress Factor

The stress factor p is solved by a general bi-section method:
1. Calculate the upper bound of p using Eq. (7c). Then the search range of p is [1, p^{upper}].
2. Assign λ=0 and assign initial value of p=1.
3. Calculate the sensitivity number \tilde{α}ₑ using Eqs. (11˜15).
4. Obtain an assumed topology which has the volume equal to the constraint V. This is similar to Step 7 in Section 3.4.2. Now the threshold is NEₜₕᵣₑ=NE×V. Sort the sensitivity numbers of the NE elements in a descend order. Then void elements above the threshold NEₜₕᵣₑ are switched to solid, and solid elements below the threshold are switched to void.
5. For the assumed new topology, estimate the compliance matrix Cᵢⱼ^{V} (i, j=1, 3) using Eqs. (16˜18). Calculate the stress factor

$${p}^{V} = - \frac{2 {C}_{33}^{V}}{{C}_{31}^{V} + {C}_{32}^{V} + {C}_{13}^{V} + {C}_{23}^{V}} \qquad ( 23 )$$

where the superscript ‘V’ refers to the volume constraint V.
6. Check the convergence of p using the following criteria:
   a. p^{V}=1.
   b. If a) is not satisfied, the change in p^{V} between the current and the last iterations is small.
7. If the above convergence criteria are not satisfied, update p according to the bi-section rule, i.e. if p^{V}>1, then p^{m+1}=½(p^{m}+p^{upper}), and the lower bound is reset as p^{lower}=p^{m}.
8. Proceed to iteration m+1. Repeat Steps 3-7 till convergence is reached. The final stress factor is taken as the average of p and p^{V}.
9. At the convergence of p, also determine whether the following stiffness constraint is activated,

$${f}_{con} = {C}_{11}^{V} - \frac{1}{{E}^{* }} \qquad ( 24 )$$

if ƒ_{con}≦0, the Lagrangian multiplier is not activated and thus λ=0.
if ƒ_{con}>0, the Lagrangian multiplier is activated. Then proceed to next the step to determine λ, as described below.

### E. Determination of the Lagrangian Multiplier

1. From Eq. (24), calculate the upper bound of λ as follows

$${λ}^{upper} = {( \frac{{C}_{11}^{V}}{1 / {E}^{*}} )}^{2} - 1 \qquad ( 25 )$$

It is noted that by applying a power of 2 in Eq. (25), the bound is further relaxed and thus the solution is searched in a wider range.
2. The stress factor is as per the already converged value of unit p=1. Assign initial value of λ=0.
3. Calculate the sensitivity number \tilde{α}ₑ using Eqs. (11˜15).
4. Obtain an assumed topology which has the volume equal to the constraint V, same as Step 4 in Section D.
5. For the assumed new topology, estimate the compliance matrix Cⱼⱼ^{V} (j=1, 3) using Eqs. (16˜18), from which the value of C₁₁^{V} is obtained.
6. Check the convergence of C₁₁^{V} using the following criteria:
7.

$${f}_{con} = {C}_{11}^{V} - \frac{1}{{E}^{*}}$$

satisfies ƒ_{con}=0.
8. If a) is not satisfied, the change in C₁₁^{V} between the current and the last iterations is small.
9. If the above convergence criteria are not satisfied, update A according to the bi-section rule, i.e.
   a) If ƒ_{con}>0, then λ^{m+1}=½(λ^{m}+λ^{upper}), and the lower bound is reset as λ^{lower}=λ^{m}.
   b) If ƒ_{con}<0, then λ^{m+1}=½(λ^{m}+λ^{lower}), and the upper bound is reset as λ^{upper}=λ^{m}.
10. Proceed to iteration m+1. Repeat Steps 3-7 till convergence is reached.

2. Negative Area Compressibility

When addressing the NLC problem, we have introduced a stress factor p to drive the linear compressibility β_{L3} to zero and then towards minimum. A similar strategy is used for NAC. Here the design objective is to minimize β_{A23}=β_{L2}+β_{L3} and it is assumed that β_{L2}=β_{L3}. In order to make the material shrink more in axes 2 and 3, a larger stress is applied in axis 1 during the early stages of the optimization process. Therefore, a stress vector incorporating the stress factor p is defined as σ={p,1,1}, where p≧1. The compressibility of the material under this stress is rewritten as

β_{L3}=½(pC₃₁+C₃₂+pC₁₃+C₂₃+2C₃₃) (27a)

β_{L2}=½(pC₂₁+C₂₃+pC₁₂+C₃₂+2C₂₂) (27b)

with C₂₁=C₃₁ and C₃₃=C₂₂ (27c)

For the same reason as given in section 3.1, the upper bound of p can be obtained by setting β_{L3}=0, i.e.

$${p}^{upper} = - \frac{{C}_{32} + {C}_{23} + 2 {C}_{33}}{{C}_{31} + {C}_{13}} \qquad ( 28 )$$

With pε[1, p^{upper}] specified, the value of p is to be determined using the bi-section method described in Section 3.4.3.1. After a number of iterations, p will converge to 1.

The optimization problem for designing NAC materials is stated as:

$$\begin{matrix}Minimize {β}_{A 23} = {β}_{L 2} + {β}_{L 3} & ( 29 a ) \\ Subject to {C}_{11} \geq \frac{1}{{E}^{*}} & ( 29 b ) \\ p = 1 & ( 29 c ) \\ {\sum }_{e = 1}^{NE} {V}_{e} {x}_{e} = V , {x}_{e} = {x}_{min} or 1 & ( 29 d )\end{matrix}$$

The Lagrangian function is

$${f}_{L} = \frac{1}{2} ( {pC}_{31} + {C}_{32} + {pC}_{13} + {C}_{23} + 2 {C}_{33} ) + \frac{1}{2} ( {pC}_{21} + {C}_{23} + {pC}_{12} + {C}_{23} + 2 {C}_{22} ) + λ ( {C}_{11} - \frac{1}{{E}^{*}} ) \qquad ( 30 )$$

Similar to the Lagrangian function for NLC optimization given in Eq. (9), the above equation has two unknowns, namely the stress factor p and the Lagrangian multiplier λ. The same methodology as detailed for NLC is used to solve these two unknowns. Then the same overall BESO procedure described above is followed to find the optimal NAC design.

3. Zero Linear Compressibility

For ZLC calculations, it was assumed that the material is under unit hydrostatic pressure and one way to measure its overall stiffness is the strain energy, i.e.

$$Π = \frac{1}{2} {\sum }_{{i = 1 , 3}_{j = 1 , 3}} {C}_{ij} .$$

To design the stiffest material with zero linear compressibility (in axis 3), we state the optimization problem as

$$\begin{matrix}Minimize Π = \frac{1}{2} {\sum }_{{i = 1 , 3}_{j = 1 , 3}} {C}_{ij} & ( 31 a ) \\ Subject to {β}_{L 3} = 0 & ( 31 b ) \\ {β}_{L 1} = {β}_{L 2} & ( 31 c ) \\ {\sum }_{e = 1}^{NE} {V}_{e} {x}_{e} = V , {x}_{e} = {x}_{min} or 1 & ( 31 d )\end{matrix}$$

The Lagrangian function is

$${f}_{L} = \frac{1}{2} ( {\sum }_{{i = 1 , 3}_{j = 1 , 3}} {C}_{ij} ) + \frac{1}{2} λ ( {C}_{31} + {C}_{32} + {C}_{13} + {C}_{23} + 2 {C}_{33} ) + {λ}_{12} ( {β}_{L 1} - {β}_{L 2} ) \qquad ( 32 )$$

Due to the cubic symmetry of the initial design, β_{L1}=β_{L2} is satisfied from the beginning and thus the last term in the above equation vanishes. The first multiplier λ is solved by using the bi-section method as detailed below.

The overall BESO procedure (outer-loop) is similar to that described previously. At each iteration an inner loop is conducted to solve the Lagrangian multiplier λ. Its value is then averaged between the current and last iterations. The procedure to determine A is as follows.
1. Assume that λ varies in the range of [0,1] and assign initial values of λ^{lower} and λ^{upper} to be equal to 0 and 1, respectively.
2. Assign the initial value of λ to be equal to 0.
3. Calculate the sensitivity number \tilde{α}ₑ using Eqs. (11˜15).
4. Obtain an assumed topology which has the volume equal to the constraint V, in the same way as in Step 4 in previous stress factor procedure.
5. For the assumed new topology, estimate the compliance matrix Cᵢⱼ^{V} (i, j=1, 3) using Eqs. (16˜18). Calculate the compressibility β_{L3}^{V}.
6. Check the convergence of β_{L3}^{V} using the following criteria:
   a) β_{L3}^{V} satisfies β_{L3}^{V}=0.
   b) If a) is not satisfied, the change in β_{L3}^{V} between the current and the last iterations is small.
7. If the above convergence criteria are not satisfied, update λ according to the bi-section rule, i.e.
   a) If β_{L3}^{V}>0, then λ^{m+1}=½(λ^{m}+λ^{upper}), and the lower bound is reset as λ^{lower}=λ^{m}.
   b) If β_{L3}^{V}<0, then λ^{m+1}=½(λ^{m}+λ^{lower}), and the upper bound is reset as λ^{upper}=λ^{m}.
8. Proceed to iteration m+1. Repeat Steps 3-7 till convergence is reached.
9. On convergence, assuming that a stress vector σ={p,p,1} is applied to the material so that β_{L3}^{V}=0, calculate the stress factor as

$${p}^{V} = - \frac{2 {C}_{33}^{V}}{{C}_{31}^{V} + {C}_{32}^{V} + {C}_{13}^{V} + {C}_{23}^{V}} \qquad ( 33 )$$

p^{V} is then used to modify the Lagrangian function as follows

$${f}_{L} = \frac{1}{2} ( {\sum }_{{i = 1 , 3}_{j = 1 , 3}} {C}_{ij} ) + \frac{1}{2} λ ( {p}^{V} {C}_{31} + {p}^{V} {C}_{32} + {p}^{V} {C}_{13} + {p}^{V} {C}_{23} + 2 {C}_{33} ) \qquad ( 34 )$$

This function is used to calculate the sensitivity of the subsequent iteration in the outer-loop.

4. Zero Area Compressibility

For ZAC calculations, the following problem statement was followed:

$$\begin{matrix}Minimize Π = \frac{1}{2} {\sum }_{{i = 1 , 3}_{j = 1 , 3}} {C}_{ij} & ( 39 a ) \\ Subject to {β}_{L 3} = 0 & ( 39 b ) \\ {β}_{L 2} = 0 & ( 39 c ) \\ {\sum }_{e = 1}^{NE} {V}_{e} {x}_{e} = V , {x}_{e} = {x}_{min} or 1 & ( 39 d )\end{matrix}$$

The Lagrangian function is

$${f}_{L} = \frac{1}{2} ( {\sum }_{{i = 1 , 3}_{j = 1 , 3}} {C}_{ij} ) + \frac{1}{2} λ ( {C}_{31} + {C}_{32} + {C}_{13} + {C}_{23} + 2 {C}_{33} ) + \frac{1}{2} λ ( {C}_{21} + {C}_{23} + {C}_{12} + {C}_{32} + 2 {C}_{22} ) \qquad ( 40 )$$

The procedure to solve the Lagrangian multiplier is similar to that in discussed above for NLC calculations. For Step 9 in calculating the stress factor, the stress vector assumed here is σ={p,1,1}, where p≧1. By setting β_{L3}=0 and β_{L2}=0, the stress factor is

$${p}^{V} = - \frac{{C}_{32}^{V} + {C}_{23}^{V} + 2 {C}_{33}^{V}}{{C}_{31}^{V} + {C}_{13}^{V}} = - \frac{{C}_{23}^{V} + {C}_{32}^{V} + 2 {C}_{22}^{V}}{{C}_{21}^{V} {+}_{12}^{V}} \qquad ( 37 )$$

which is used to modify the Lagrangian function as follows

$${f}_{L} = \frac{1}{2} ( {\sum }_{{i = 1 , 3}_{j = 1 , 3}} {C}_{ij} ) + \frac{1}{2} λ ( {p}^{V} {C}_{31} + {C}_{32} + {p}^{V} {C}_{13} + {C}_{23} + 2 {C}_{33} ) + \frac{1}{2} λ ( {p}^{V} {C}_{21} + {C}_{23} + {p}^{V} {C}_{12} + {C}_{32} + 2 {C}_{22} ) \qquad ( 38 )$$

This function is used to calculate the sensitivity of the subsequent iteration in the outer-loop.

### EXAMPLES

### Example 1

### Cubic Base Cell with Spherical Shape Void

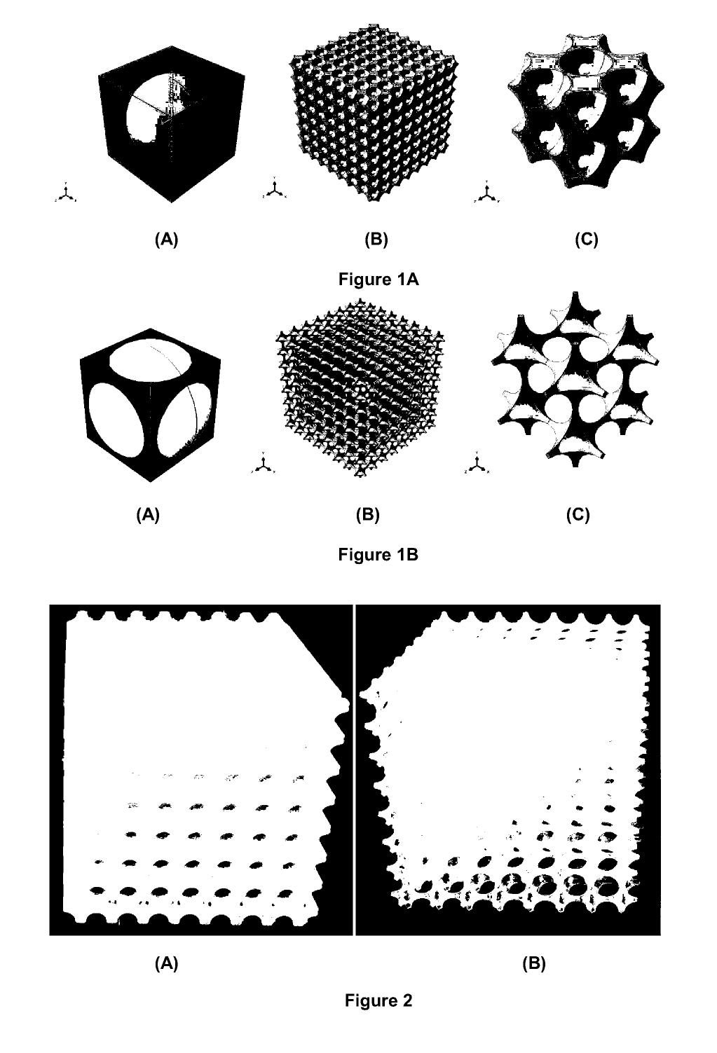

The geometry of the base cell for this example 3D auxetic metamaterial is formed by creating a hollow spherical cavity inside a cube, as shown in FIG. 1A(A) and FIG. 1B(A). Each of the building cells was repeated to form a 3D cellular material as respectively shown in FIG. 1A(B) and FIG. 1B(B). The experimental bulk metamaterial was constructed by repeating nine building cells along three normal directions and cut half of the both end-cells in each direction. Each of the specimens of the bulk 3D material were manufactured using 3D printing (ObjetConnex350) with a silicone-based rubber material (TangoPlus) and a supporting material.

According to the deformation pattern after buckling, the Representative Volume Element (RVE) contains four building cells as shown in FIG. 1A(C) and FIG. 1B(C). According to the ratio (R) of the diameter of the sphere to the length of the cube, two resultant geometry were established:
(1) a face-centred cubic cell with 0<R<1 (FIG. 1A(A)), which is used as a comparative design for the present invention; and
(2) an inventive cubic cell 1<R<2 (FIG. 1B(A)) which comprises a metamaterial in accordance with an embodiment of the present invention. The porosity of this unit cell was found to be in the range of 0.69 to 0.97.

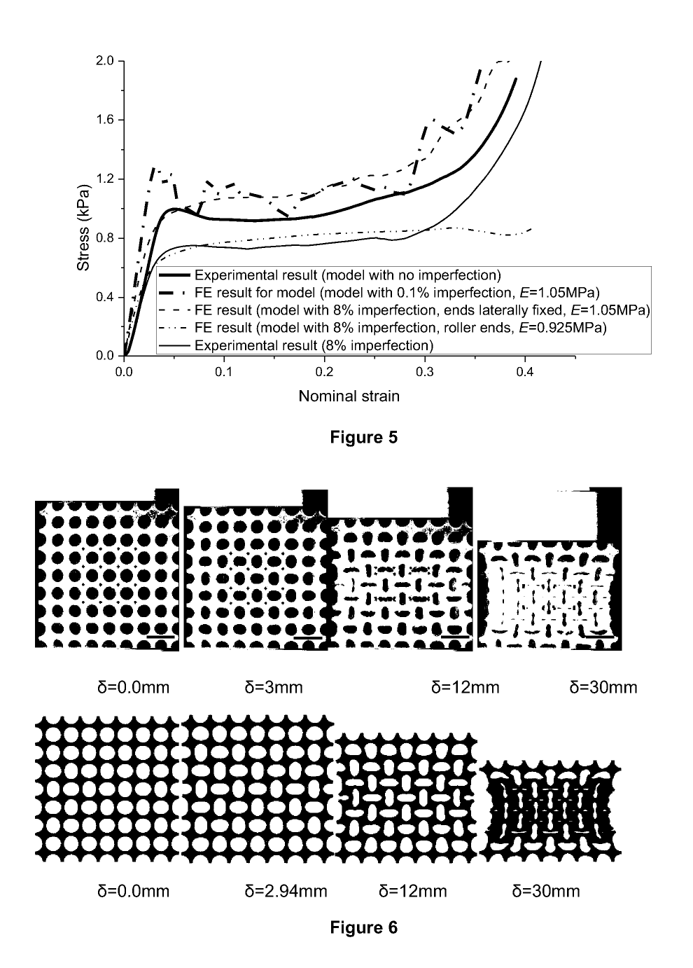

The material properties of the printed TangoPlus material were measured through standard compression test with six printed cylinders, up to the true strain of ε=0.70. Each of the 3D materials and their responses to strain and compression were also modelled as a linear elastic model using finite element analysis. A comparison of the deformation patterns between the experimental (A) and model (B) is provided in FIG. 4. Comparative Force-Displacement curves of the experimental (A) and model (B) are shown in FIGS. 5A and 5B.

The results indicate that the constitutive behaviour of each of the comparative face-centred cubic cell and inventive cubic cell could be accurately represented by a linear elastic model. It should be noted that the printed TangoPlus material exhibited slightly anisotropic behaviour with the Young's modulus along printing direction, 0.925±0.02 MPa, being slightly lower than its lateral direction, 1.05±0.03 MPa. The Poisson's ratio of the face-centred cubic cell was found to be +0.47.

The performance of the inventive 3D cubic metamaterial was tested using standard compression tests similar to those commonly used for other cellular materials. To obtain a reliable homogenized material properties, the dimensions of the test specimens were selected as height×width×depth=100.0×100.0×100.0 mm. This resulted in a material built from a matrix having eight building cells in each normal direction as shown in FIG. 1B(B).

Two samples of the inventive cubic cell material are shown in FIG. 2. The left sample (A) still includes supporting material for the 3D printing. The right sample (B) has the supporting material removed. In spite of extreme care being taken during the removal of the supporting material, a few of the thinnest links in the bulk material were broken. An epoxy adhesive was used to repair that damage.

Comparative compression tests between the (1) comparative face-centred cubic cell and (2) the inventive cubic cell. The compression tests were conducted at a fixed strain rate of 10⁻³ s⁻¹ using a Shimazu machine. Two cameras were used to capture the deformation in two lateral directions so as to determine the evolution of the Poisson's ratio of the metamaterial. The end strain were fixed at a nominal strain up to 0.3 for specimen formed from the comparative face-centred cubic building cells and 0.5 for specimens with inventive cubic building cells to avoid potential damage of the specimens. It was found that within these strain ranges, the deformation was purely elastic and totally reversible.

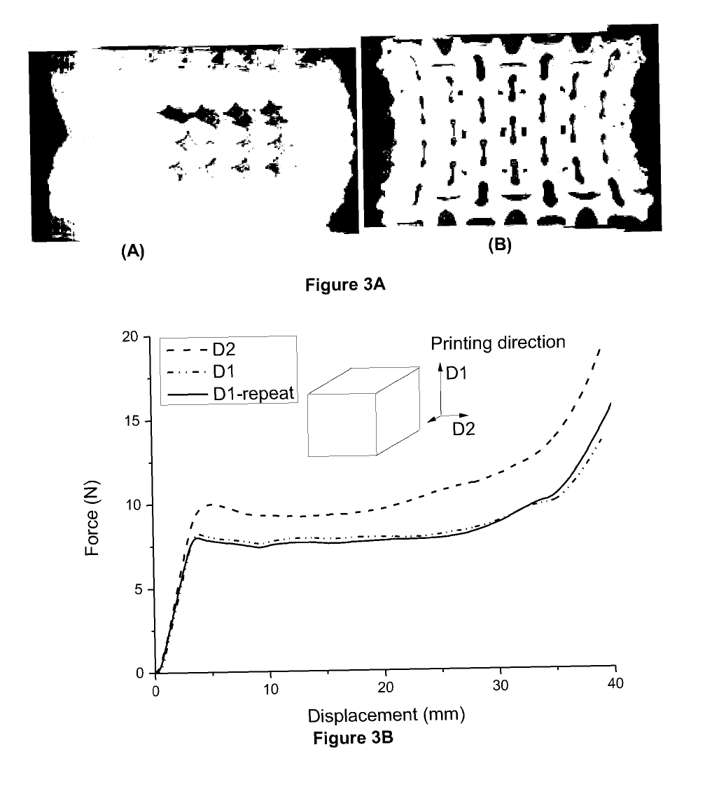

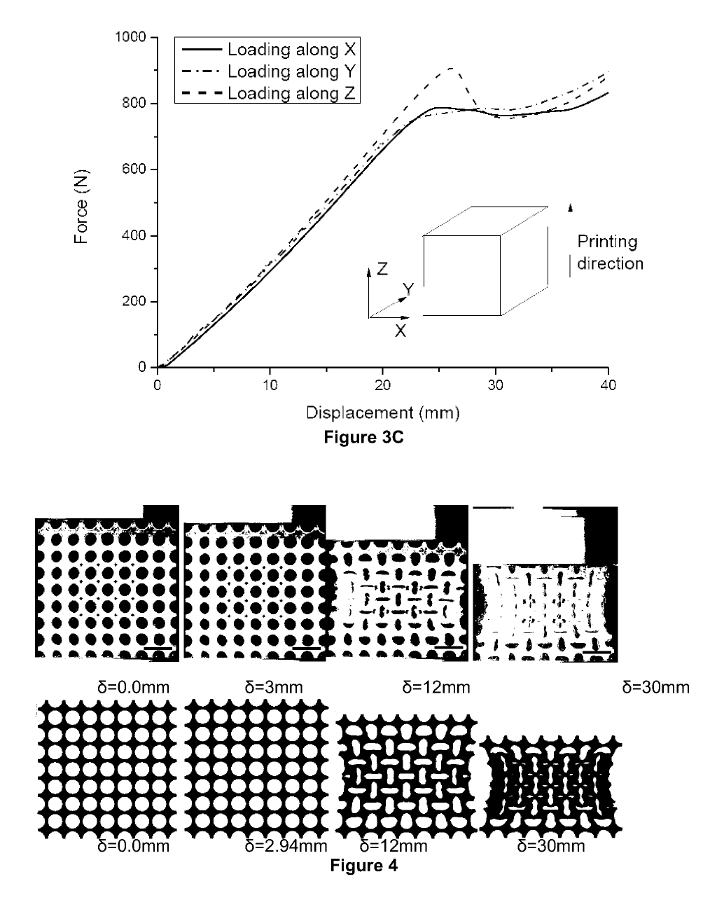

The bulk material composed of the comparative face-centred cubic building cells only exhibited global buckling at a very large strain of 0.25 as shown in FIG. 3A(a). Furthermore, as shown in FIG. 3B the stress-strain curve is linear before the buckling occurs. No obvious auxetic behaviour was observed. The Applicant notes that the localised buckling modes with alternating ellipsoids similar to 2D NPR materials reported in for example Overvelde et al (Compaction Through Buckling in 2D Periodic, Soft and Porous Structures: Effect of Pore Shape. Advanced Materials. 2012; 24:2337-2342) did not occur for this type of material.

The bulk material composed of the inventive cubic building cells, showed localised buckling modes with alternating ellipsoids. This material therefore deformed with clearly observable auxetic behaviour as shown in FIG. 3A(b). Furthermore, the force-deflection response of inventive metamaterial (shown in FIG. 3C) in two different directions D1 and D2 also shows observable auxetic response.

The different buckling behaviour of the materials formed from the face-centred cubic building cell and inventive cubic cell indicates that there is a critical porosity or volume fraction for the desired buckling mode. In this respect, auxetic behaviour is not possible when the porosity of the material is below 0.60, for example the face-centred cubic building cell material. The Applicants have unexpectantly found that a porosity of at least 0.6, preferably between 0.6 and 0.9 is necessary for the 3D material to display auxetic behaviour.

### Example 2

### Mechanism Analysis (Buckling Mode)

Numerical simulations were carried out using the commercial finite element (FE) software package ABAQUS (Simulia, Providence, R.I.) to determine the mechanisms of the auxetic behaviour observed in the inventive metamaterial discussed in Example 1.

The ABAQUS/standard solver was employed for buckling analysis and ABAQUS/explicit solver was employed for postbuckling analyses. Quadratic solid elements with secondary accuracy (element type C3D10R with a mesh sweeping seed size of 0.4 mm) were used. The analyses were performed under uniaxial compression. The buckling mode with 3D alternating ellipsoidal pattern from buckling analysis was used as the shape change or imperfection factor for non-linear (large deformation) post-buckling analysis. The finite element models were validated using experimental results.

FIG. 4 shows the comparison of deformation process of the metamaterial from numerical simulation and experimental result from one direction. Both the experimental results (A) and modelled behaviour (B) exhibit the auxetic behaviour in a similar manner. A noticeable difference is the long axis of ellipsoid of the representative volume unit (marked with dots) in the centre of the specimen. The similarity remained in the other lateral direction. According to the linear buckling analysis, these two different deformation patterns have nearly identical eigenvalues. Based on this analysis, the inventors consider that the actual deformation pattern after buckling is determined by the imperfection of the initial geometry.

It was found that the buckling mode was influenced by the boundary conditions of the FE model. Two boundary conditions were examined. One constrains all freedoms of the nodes on top and bottom surface except for the freedom on loading direction on the top surface and the other constrains only the freedom of the nodes bottom surface along loading direction. For the former boundary condition, the first buckling mode from the numerical simulation exhibited local buckling with alternating ellipsoids. For the latter boundary condition, the first buckling mode exhibited a planar pattern which was similar to the deformation patterns observed previously by Willshaw and Mullin (Soft Matter. 2012, 8, 1747). The 3D buckling pattern occurred as the fifth buckling mode.

It can also be observed from FIG. 4 that the deformation of the specimen is uniform at the early stage of the compression test before buckling occurs. The material behaves like conventional material with a positive Poisson's ratio. Only after the buckling occurred, the auxetic behaviour become evident, which indicated the value of negative Poisson's ratio is changing during the deformation process. This could be a disadvantage for applications with a required negative Poisson's ratio.

### Example 3

### Cubic Base Cell with Ovoid Shaped Void

To overcome the buckling disadvantages of Example 1 and 2, the geometry of the base cell for this example 3D auxetic metamaterial is formed by creating a hollow ovoid cavity inside a cube, as shown in FIG. 6. The designed ovoid comprised an 8% imperfection in the shape of the spherical void used in the material discussed in Examples 1 and 2. In addition, the matrix of base units in the material was arranged such that the central length axis of the ovoid void of each base unit was perpendicular to the central length axis of the ovoid void of each adjoining base unit. This, in effect, introduced the pattern of the buckling mode seen in Examples 1 and 2 into the void pattern of this embodiment of the metamaterial. The porosity of this unit cell was found to be 87.4% for Example 1 and 87.2% for Example 2.

A direct comparison of nominal stress-strain curves between experimental and numerical results is shown in FIG. 5. Both curves exhibit a similar trend and the corresponding stress are at similar levels. This demonstrates general agreement between experimental results and the finite element model. It is noted that the lower stress level in the experimental results could be attributed to the broken links during the removal process of the supporting material. The stress-strain curves of the inventive metamaterial are similar to the other cellular materials undergoing plastic deformation, with the difference that deformation of the inventive metamaterials is purely elastic and fully reversible. This appears to be an attribute of the properties of the base material used.

The overall deformation patterns for the proposed metamaterial with 8% imperfection (of the spherical shape of the voids) are shown in FIG. 6, and it is clear that the auxetic behaviour starts from the very beginning.

The Applicant observes that if the magnitude of the imperfection in the spherical shape of the void is increased (and thus the shape of the ovoid void altered or flattened), the Poisson's ratio of material could be altered, and thus effectively tailored to a desired value. This would produce a series of inventive cubic 3D metamaterials with prescribed initial negative Poisson's ratio value. This approach provides a fundamentally new way for generating a serial of 3D materials with a desired initial value of negative Poisson's ratio.

It should be noted that the volume fraction for the base cell and representative volume element of the inventive metamaterial varies with different imperfection magnitude. A combination of this approach with the initial geometry design can therefore be considered to design metamaterials with a desired volume fraction.

The above shows that the configuration of the base unit, void geometry and pattern of the matrix formed from the base units can be tailored using a buckling mode obtained through finite element analysis. The introduction of the buckling pattern into the matrix of the material and varying the magnitude of the imperfection in the spherical shape of the void enables so that it provides a mean to tailor the initial value of Poisson's ratio in a range from 0 to −0.5.

### Example 4

### Cubic Base Cell with Tetrahedron or Ellipsoid Shaped Void

A metamaterial of the present invention can also be formed using a cubic base cell with other void shapes, such as tetrahedron, or ellipsoid.

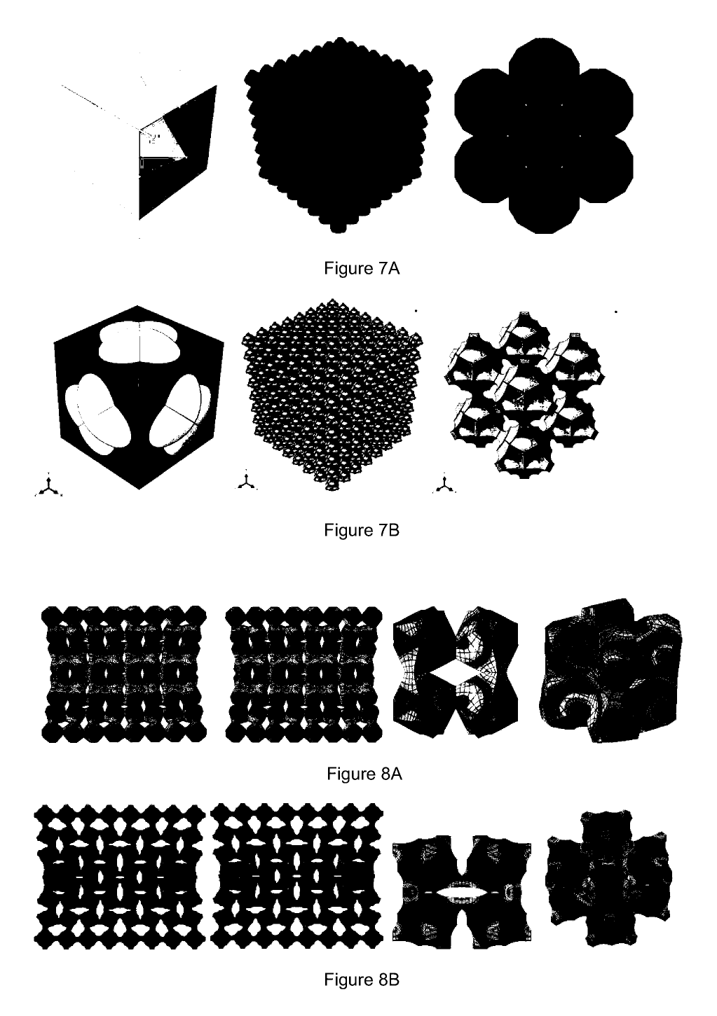

FIG. 7A provides the geometric configurations for a three dimensional structure porous metamaterial with tetrahedron in cube building cell. FIG. 7B provides the geometric configurations for a three dimensional structure porous metamaterial with ellipsoid in cube building cell. The geometry of the base cell for this example 3D auxetic metamaterial is formed by creating a hollow tetrahedron or ellipsoid cavity inside a cube, as shown in FIG. 7A(A) and FIG. 7B(A). Each of the building cells was repeated to form a 3D cellular material as respectively shown in FIG. 7A(B) and FIG. 7B(B). FIG. 7A(C) and FIG. 7B(C) illustrate a representative volume unit of the inventive metamaterial.

The porosity of this type of unit cell was found to be 0.63 in FIG. 7A (in the range of 0.5 to 0.91) and 0.69 in FIG. 7B (in the range of 0.6 to 0.97).

Tests have shown that this material has similar deformation behaviour as with previous cubic base cell with spherical voids. FIG. 8A provides the deformation pattern of the metamaterial shown in FIG. 7A under load. FIG. 8B provides the deformation pattern of the metamaterial shown in FIG. 7B under load. The deformation pattern shown in FIGS. 8A and 8B illustrates similar behaviour with previous cubic base cell with spherical voids examples.

### Example 5

### Metamaterial with Negative Linear Compression (NLC) Under Uniformed Pressure

A negative compression (NC) metamaterial of the present invention can be formed using a frame work similar to the topology resulting from bi-directional evolutionary structural optimization (BESO).

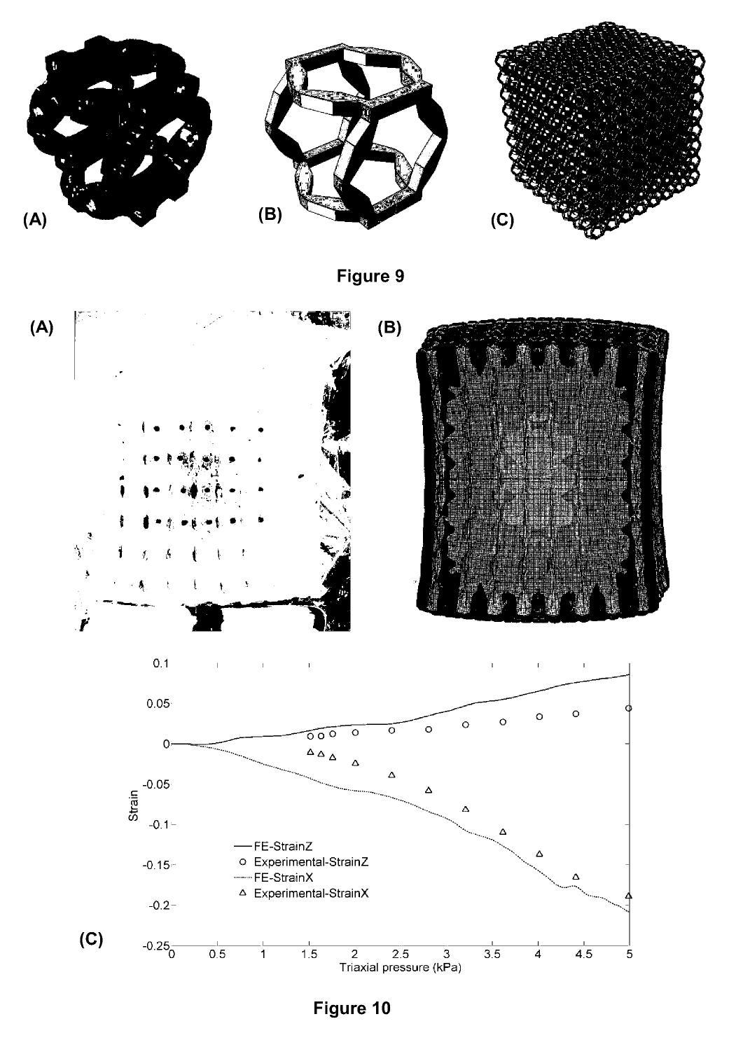

FIG. 9 provides the geometric configurations for the resulting three dimensional structure porous NC metamaterial with NLC. FIG. 9(A) provides the topology obtained from BESO. The geometry of the building cell for this example 3D NC metamaterial is formed by simplifying the irregular members in FIG. 9(A) to a truss with varied cross-section maximized at the middle span. The simplified building cell is shown in FIG. 9(B). Each of the building cells was repeated to form a 3D cellular material as respectively shown in FIG. 9(C). The porosity of this unit cell was found to be 0.902.

As shown in FIG. 9(A), the basic form of the NLC metamaterial is derived from BESO calculations, as discussed previously in relation to NLC optimisation.

In these calculations for this and subsequent examples, the finite element analysis is conducted by using ABAQUS version 10.1. Due to symmetry in three directions for orthotropic materials, only one eighth of the unit cell needs to be modelled. The one eighth model is divided into a mesh of 30×30×30 brick elements (element type: C3D8). The resulting topology is smoothened based on curve and surface fitting. The target volume V is 30%. The unit for the compressibility is Pa⁻¹.

For the BESO calculations, the base materials are E_{b1}=10⁻¹⁵ (void) and E_{b2}=1 (solid). To represent an impressible base material (such as silicon rubber) the Poisson's ratio v_{b} is assumed to be 0.49. It is noted that for a given target volume V (which is the same as the volume fraction as the total volume of the unit cell is 1), the maximum achievable stiffness along a single axis is Eₘₐₓ=VE_{b2}. The stiffness target is then specified as E*=aEₘₐₓ=aVE_{b2} where a is the prescribed stiffness ratio. The stiffness ratio a is equal to 0.10. Therefore E*=aVE_{b2}=0.10×0.3×1=0.030.

The result is shown in FIG. 9, with the unit cell having a topology similar to a truss-like system. The linear compressibility β_{L3} is −17.53. Furthermore:

$$\begin{matrix}E matrix & C matrix \\ [ \begin{matrix}0.068 & 0.008 & 0.063 \\ 0.008 & 0.068 & 0.063 \\ 0.063 & 0.063 & 0.141\end{matrix} ] & [ \begin{matrix}33.302 & 16.538 & - 22.171 \\ 16.538 & 33.302 & - 22.171 \\ - 22.171 & - 22.171 & 26.807\end{matrix} ]\end{matrix}$$

$${β}_{L 1} = {β}_{L 2} = 27.67 , {β}_{L 3} = - 17.53 , {E}_{1} = {E}_{2} = 0.030 , {E}_{3} = 0.037 , \\ {v}_{12} = - 0.497 , {v}_{23} = {v}_{13} = 0.666$$

The procedure has designed an optimised shaped void comprising a regular but complex shape, providing a cutout aperture in the truss structure, and an open end.

To verify the above material properties, a numerical simulation of a stress test was conducted on a model constructed from 8×8×8 unit cells of the above topology. The model is resized to 100 mm×100 mm×100 mm and was meshed with 7424 quadratic tetrahedral elements (ABAQUS element type C3D10I). A hydrostatic pressure P=−1.44×10⁻³ is applied through rigid plates attached to the six faces. Displacements at the rigid plates are extracted and then strains are calculated, which result in ε₁=ε₂=−41.39×10⁻³ and ε₃=24.69×10⁻³, respectively. Normalizing these strains by the pressure P gives the following values of linear compressibility: β_{L1}=β_{L2}=28.74 and β_{L3}=−17.15, which are very close to calculated values, with differences being less than 4%. The discrepancies are attributed to the different finite element models used for the unit cell and the array of 8×8×8 cells.

Tests have shown that this metamaterial expand in one direction while shrinking in the other two directions under pressure. In these tests, the NLC design shown in FIG. 9 was obtained by assuming a nearly incompressible base material with a Poisson's ratio of 0.49. A bulk material model is constructed from 8×8×8 unit cells of this topology. The model is resized to 100 mm×100 mm×100 mm. Using a 3D printer (Object Connex350), a prototype model was fabricated with a silicone-based rubber material (TangoPlus) and a support material in lower density. After the support material has been carefully removed, the NLC material design as shown in FIG. 10(A) was obtained. In the following discussions, X, Y and Z directions correspond to axes 1, 2 and 3, respectively. The material properties of the TangoPlus material are measured through standard compression test on three printed cylindrical samples, with the true strain up to 0.70. The results indicate that the constitutive behaviour of the base material can be accurately represented by a linear elastic model. It is found that the Young's modulus is 1.05 MPa and the Poisson's ratio is 0.48. These values are used in the FE simulations described below.

### Uniaxial Compression Test

Uniaxial compression tests were conducted in the X, Y or Z direction separately. From these experiments, the effective (average) compliance matrix for the bulk material can be obtained. Also, linear elastic finite element analyses of the bulk material model with 8×8×8 cells are performed by applying unidirectional pressures through two rigid plates. From the FE results, the effective compliance matrix of the material can be calculated as well. The compliance matrix for the unit cell and the effective compliance matrices for the model with 8×8×8 cells from both experimental and FE results (all normalized with respect to Young's moduli) are given in Table 1.

TABLE 1

| | C Matrix |
|---|---|
| Unit cell (FIG. 2) | $[ \begin{matrix}33.302 & 16.538 & - 22.171 \\ 16.538 & 33.302 & - 22.171 \\ - 22.171 & - 22.171 & 26.807\end{matrix} ]$ |
| 8 × 8 × 8 cells, FE results | $[ \begin{matrix}36.843 & 15.431 & - 23.282 \\ 15.431 & 36.835 & - 23.281 \\ - 23.217 & - 23.175 & 29.632\end{matrix} ]$ |
| 8 × 8 × 8 cells, experimental results | $[ \begin{matrix}39.68 & 13.17 & - 21.03 \\ 13.17 & 39.68 & - 21.03 \\ - 22.79 & - 22.79 & 31.43\end{matrix} ]$ |

It is seen that the FE results agree reasonably well with the experimental data.

It is noted that the C matrix for the unit cell and that of the 8×8×8 cells (FE results) are also similar. The discrepancies are mainly attributed to different boundary conditions. For the unit cell, periodic boundary conditions are applied; while for the bulk material model, all nodes on top and bottom surfaces are only allowed to move in the loading direction.

### Triaxial Compression Test

In order to examine the behaviour of the NLC design under uniform pressure, a tri-axial pressure test was performed using a standard tri-axial test machine commonly used for soil testing. Firstly the prototype was put inside a sealed plastic bag, to which a plastic tube of 2 mm in diameter is connected. During the application of the uniform pressure on the outside surface of the plastic bag, the air inside the bulk material is pressed out through the plastic tube. The uniform pressure is gradually increased from 0 to 5 kPa. The final deformed shape of the material at 5 kPa is given in FIG. 10(A). It is seen that the original cube has become narrower and taller under uniform pressure—a clear sign of the NLC effect.

A finite element simulation of the tri-axial test has been conducted. To capture the large deformation observed in the experiment, a nonlinear finite element analysis considering large deformation is carried out. The base material is assumed linear elastic, with Young's modulus E₀=1.05 MPa and μ₀=0.48. The plastic bag is modelled using membrane elements, with thickness t=0.2 mm, Young's modulus Eₘ=6 MPa and μₘ=0.48. The deformed shape of the model at 5 kPa from the FE simulation is given in FIG. 10(B), which is very similar to the experimental result shown in FIG. 10(A). Furthermore, the average strains in X and Z directions from the experiment and the FE simulation are given in FIG. 10(C). The experimental data agree reasonably well with the FE results.

### Example 6

### Metamaterial with Negative Area Compression (NAC) Under Uniformed Pressure

FIG. 11 provides the geometric configurations for a three dimensional structure porous negative compression metamaterial with NAC. FIGS. 11(A—half cell) and 11(B—full unit cell) provides the topology obtained from bi-directional evolutionary structural optimization (BESO) as discussed previously in relation to NAC optimisation calculations.

The porosity of this unit cell was found to be 0.696.

In the BESO calculations, the base materials were assumed to have E_{b1}=10⁻¹⁵ and a common Poisson's ratio and a stiffness ratio a=0.05. The calculated parameters were:

$$\begin{matrix}E matrix & C matrix \\ [ \begin{matrix}0.038 & 0.060 & 0.060 \\ 0.060 & 0.227 & 0.082 \\ 0.082 & 0.082 & 0.227\end{matrix} ] & [ \begin{matrix}67.248 & - 13.121 & - 13.121 \\ - 13.121 & 7.610 & 0.744 \\ - 13.121 & 0.744 & 7.610\end{matrix} ]\end{matrix}$$

$${β}_{A 23} = - 9.534 , {β}_{L 2} = {β}_{L 3} = - 4.767 , {E}_{1} = 0.015 , \\ {E}_{2} = {E}_{3} = 0.131 , {v}_{12} = {v}_{13} = 0.195 , {v}_{23} = - 0.098$$

The resulting topology is shown in FIGS. 11(A) and 11(B). The topology is symmetrical with respect to the 45 degree plane perpendicular to plane 2-3. The stiffness in axis 1 is E₁=0.015 which is the same as that of the NLC design in Example 5 because both designs have the same stiffness constraint. The compressibility of the NLC design β_{L3} is equal to −44.21 as compared to here β_{L3}=β_{L2}=−4.767. It is noted that the absolute value of the compressibility of the NAC material is significantly smaller than that of the NLC material discussed in the previous example, even though they have the same stiffness in one direction. The procedure has designed an optimised shaped void comprising multiple voids within the cubic base unit forming a complex shape. In this respect, the optimised shape void includes two internal voids and three external voids forming the topology of the base building cell.

The geometry of the building cell for this example 3D NC metamaterial is formed by simplifying the irregular members in FIG. 11(B) to a truss with varied cross-section maximized at the middle span. The simplified building cell is shown in FIG. 11(C). Each of the building cells was repeated to form a 3D cellular material as respectively shown in FIG. 11(D).

### Example 7

### Metamaterial with Zero Linear Compressibility (ZLC) Under Uniformed Pressure

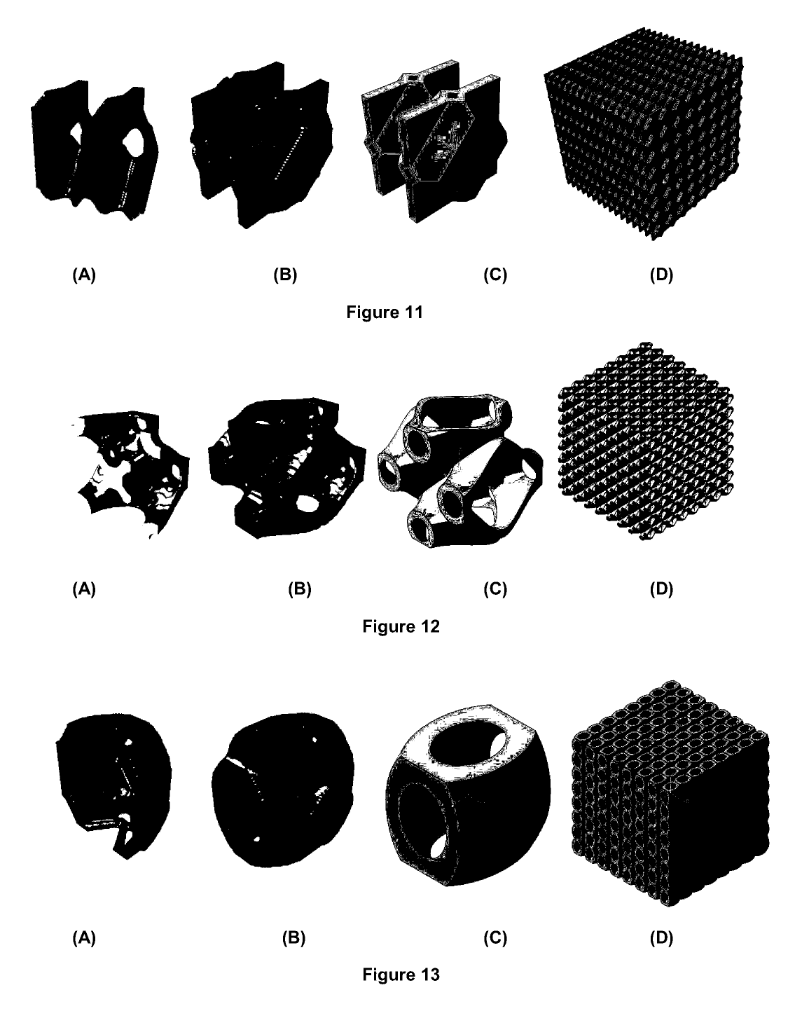

FIG. 12 provides the geometric configurations for a three dimensional structure porous negative compressibility metamaterial with ZLC. FIG. 12(A—half cell) and FIG. 12(B—full cell) provides the topology obtained from bi-directional evolutionary structural optimization (BESO).

In the BESO calculations, the procedure provided in Example 5 was used to determine a ZLC design. The material was designed with constraint on the linear compressibility, i.e. β_{L3}=0, is shown in FIG. 7 and a strain energy of 6.33. The linear compressibility β_{L3} equals −0.002, which is very close to zero. The procedure has designed an optimised shaped void comprising multiple voids within the cubic base unit forming a complex shape. In this respect, the optimised shape void includes two internal voids and at least three external voids (sides) forming the topology of the base building cell.

The calculated parameters were:

$$\begin{matrix}E matrix & C matrix \\ [ \begin{matrix}0.124 & 0.034 & 0.079 \\ 0.034 & 0.126 & 0.079 \\ 0.079 & 0.079 & 0.173\end{matrix} ] & [ \begin{matrix}11.438 & 0.228 & - 5.334 \\ 0.228 & 11.438 & - 5.334 \\ - 5.334 & - 5.334 & 10.665\end{matrix} ]\end{matrix}$$

$${β}_{L 3} = - 0.002 , {E}_{1} = {E}_{2} = 0.087 , {E}_{3} = 0.094 , {v}_{12} = - 0.020 , \\ {v}_{23} = {v}_{13} = 0.466$$

The geometry of the building cell for this example 3D NC metamaterial is formed by simplifying the irregular members in FIG. 12(B) to a truss with varied cross-section maximized at the middle span. The simplified building cell is shown in FIG. 12(C). Each of the building cells was repeated to form a 3D cellular material as respectively shown in FIG. 12(D).

The porosity of this unit cell was found to be 0.854.

### Example 8

### Metamaterial with Zero Area Compressibility (ZAC) Under Uniformed Pressure

FIG. 13 provides the geometric configurations for a 3D structure porous negative compressibility metamaterial with ZAC. FIGS. 13(A—half cell) and 13(B—full unit cell) provides the topology obtained from BESO.

In the BESO calculations, the material is designed to the ZAC criterion following a procedure corresponding to the ZLC example (Example 7). The result is shown in FIGS. 13(A) and (B). The calculated parameters were:

$$\begin{matrix}E matrix & C matrix \\ [ \begin{matrix}0.071 & 0.071 & 0.071 \\ 0.071 & 0.173 & 0.090 \\ 0.071 & 0.090 & 0.173\end{matrix} ] & [ \begin{matrix}30.681 & - 8.335 & - 8.335 \\ - 8.335 & 14.935 & - 1.905 \\ - 8.335 & - 1.905 & 10.238\end{matrix} ]\end{matrix}$$

$${β}_{A 23} = - 0.002 , {β}_{L 2} = {β}_{L 3} = - 0.001 , \\ {E}_{1} = 0.033 , {E}_{2} = {E}_{3} = 0.098 , {v}_{12} = {v}_{13} = 0.272 , {v}_{23} = 0.186$$

The strain energy is 7.00, which is higher than that of ZLC (6.33). This is because of the additional constraint on β_{L2} compared to the ZLC design. The area compressibility β_{A23} is equal to −0.002, which is negligibly small (in terms of its absolute value) compared to that of the NAC design shown in FIG. 11 (Example 6) (−25.40). The procedure has designed an optimised shaped void comprising multiple voids within the cubic base unit forming a complex shape. In this respect, the optimised shape void includes an internal void and at least two external voids (sides) forming the topology of the base building cell.

The porosity of this unit cell was found to be 0.893.

The geometry of the building cell for this example 3D NC metamaterial is formed by simplifying the irregular members in FIG. 13(B) to a truss with varied cross-section maximized at the middle span. The simplified building cell is shown in FIG. 13(C). Each of the building cells was repeated to form a 3D cellular material as respectively shown in FIG. 12(D).

There are several special features about the performance of the metamaterial of the present invention:
The deformation of embodiments of the inventive metamaterials are purely elastic and fully reversible like other elastomers, but the stress-strain curves of our NPR metamaterials exhibits plateau feature as other cellular material undergo plastic deformation. The negative Poisson's ratio of the inventive metamaterials is retained over a wide range of applied strain and the range can be altered by the initial volume fraction and the magnitude of imperfection.
The proposed design approach can be applied to any length-scale. It can be extended for tuning other properties of a material from the smallest scale.
The inventive metamaterial can also be combined with stimuli responsive material to switch between different deformation patterns.

The material of the present invention can be used to fabricate sensors, actuators, prosthetics, surgical implants, anchors, (as for sutures, tendons, ligaments, or muscle), fasteners, seals, corks, filters, sieves, shock absorbers, impact-mitigating materials, hybrids, or structures, impact absorption or cushioning materials, hybrids, or structures, wave propagation control materials, hybrids, or structures, blast-resistant materials, hybrids, or structures, micro-electro-mechanical systems (MEMS) components, and/or stents.

Applications of this invention directed at the biomedical field include uses relating to prosthetic materials, surgical implants, and anchors for sutures and tendons, endoscopy, and stents.

Applications of this invention directed the mechanical/electrical field include uses in piezoelectric sensors and actuators, armours, cushioning, and impact and blast resistant materials, as deployable material and defence materials for infrastructures, the filter and sieve field, the fastener field, the sealing and cork fields, and the field of micro-electro-mechanical systems (MEMS).

In one exemplary embodiment, the inventive metamaterial can be formed as a compressible biocompatible polymer for use in intervertebral disc replacement. In some forms, the configuration and patterning the voids can be configured to allow the flow of fluid. The fluid can be used as a dampening mechanism within the material.

An immediate application of NLC/NAC metamaterials is the optical component in interferometric pressure sensors due to the higher sensitivity achieved by a combination of large volume compressibility with negative linear compressibility.

One significant application of the NC metamaterials is to be used as inserted foam for the OA treatment surgery using a NPWT system. The NC metamaterial will maintain their height but contract laterally under negative pressure and thereby enable the OA wound to close directly without using invasive mechanical devices.

With further understanding the mechanisms of negative compressibility, NLC/NAC materials also have potential to be used as efficient biological structures, nanofluidic actuators or as compensators for undesirable moisture-induced swelling of concrete/clay-based engineering materials (Cairns et al., 2013).

In exemplary embodiments, the inventive metamaterials can be used in a new type of smart amour for defence engineering or in blast control from explosive devices and projectiles. In one embodiment, the inventive material is formed from a Titanium or titanium alloy base unit matrix. The material can be used to compresses to the point of impact thereby providing lightweight armour plating.

In yet another exemplary application, the material can be used as lightweight cellular materials with enhanced energy absorption for motor vehicles.

Those skilled in the art will appreciate that the invention described herein is susceptible to variations and modifications other than those specifically described. It is understood that the invention includes all such variations and modifications which fall within the spirit and scope of the present invention.

Where the terms “comprise”, “comprises”, “comprised” or “comprising” are used in this specification (including the claims) they are to be interpreted as specifying the presence of the stated features, integers, steps or components, but not precluding the presence of one or more other feature, integer, step, component or group thereof.

1. A structured porous metamaterial comprising a three-dimensional matrix of at least one repeating base unit, the matrix formed from an array of at least eight base units, each base unit comprising a platonic solid including at least one shaped void, wherein the geometry of the at least one shaped void of each base unit is tailored to:
provide a porosity of between 0.3 and 0.97; and
provide the metamaterial with a response comprising at least one of:
a Poisson's ratio of 0 to −0.5 when under tension and compression; or
negative linear compression (NLC), negative area compression (NAC), zero linear compression (ZLC), or zero area compression (ZAC) behaviour when under pressure.

2. A metamaterial according to claim 1, wherein the base unit comprises at least one of a tetrahedron, cube, cuboid, parallelepiped, octahedral, dodecahedron, or icosahedron.

3. (canceled)

4. A metamaterial according to claim 1, wherein the base unit includes a geometric center, and the geometry of the void is centered about that geometric center.

5. A metamaterial according to claim 1, wherein the base unit includes a width, height and length, and the at least one dimension of the base geometric shape of the void is larger than at least one of the width, height or length of the base unit.

6. A metamaterial according to claim 1, wherein the void comprises at least one of:
a truncated form of a base geometric shape; or
an interconnected combination of at least two geometric shapes.

7. (canceled)

8. A metamaterial according to claim 1, wherein the void includes an opening in at least one, preferably two sides of the base unit.

9-10. (canceled)

11. A metamaterial according to claim 1, wherein the base geometric shape of the voids comprises at least one of spherical, ovoid, ellipsoid, cubic, cuboid, parallelepiped, hyperboloid, conical.

12. A metamaterial according to claim 1, wherein the void geometry of the base unit is tailored to provide a porosity of one of:
between 0.69 and 0.97 for a spherical shaped void;
between 0.30 and 0.90 for regular non-spherical shaped voids; or
between 0.3 and 0.98 for optimised shaped voids.

13. A metamaterial according to claim 1, wherein shaped void comprises an optimised shaped void formed using optimization algorithms, preferably bi-directional evolutionary structural optimization.

14. A metamaterial according to claim 1, wherein the base unit comprises a cube and the base geometric shape of the void comprises a sphere.

15. A metamaterial according to claim 1, wherein the base geometric shape of the void comprises shape having a greater central length than central height, the shape having a central length axis, the matrix of base units being arranged such that the central length axis of the void of each base unit is perpendicular to the central length axis of the void of each adjoining base unit.

16. A metamaterial according to claim 15, wherein the void shape comprises an ovoid or an ellipsoid.

17. A metamaterial according to claim 1, wherein the base unit is cubic and the shaped void is ellipsoid and wherein the porosity is between 0.3 and 0.87.

18. A metamaterial according to claim 1, wherein the base unit includes at least two shaped voids.

19. A metamaterial according to claim 1, comprising a three-dimensional matrix of at least two different repeating base units, comprising a first base unit comprising platonic solid including a first shaped void and a second base unit comprising platonic solid including a second shaped void.

20. (canceled)

21. A metamaterial according to claim 1, wherein the voids are composed of a compressible material, preferably a compressible material having a high compressibility.

22. A metamaterial according to claim 1, wherein the voids include at least one fluid, preferably at least one liquid.

23-27. (canceled)

28. A method of determining the configuration of a structured porous metamaterial comprising a three-dimensional matrix of at least one repeating base unit, comprising:
determining a base unit topology using a structural optimization algorithm, each base unit comprising a platonic solid including at least one shaped void, the geometry of the at least one shaped void of each base unit being tailored to provide a metamaterial with a porosity of between 0.3 and 0.97 and a response comprising at least one of:
a Poisson's ratio of 0 to −0.5 when under tension and compression; or
negative linear compression (NLC), negative area compression (NAC), zero linear compression (ZLC), or zero area compression (ZAC) behaviour when under pressure; and
simplifying the configuration of the at least one shaped void of each base unit to form a structural base unit; and
forming a three-dimensional matrix from an array of at least eight structural base units.

29. A method according to claim 28, wherein the configuration of the shaped voids within each base unit is derived from a bi-directional evolutionary structural optimization (BESO) model.

30. A method according to claim 28, wherein the step of simplifying the configuration of the at least one shaped void of each base unit comprises reconfiguring the topology of the shaped void or voids to have a more regular geometric shape.

31-33. (canceled)
